(19) United States
(12) Patent Application Publication
(10) Pub. No.: US 2026/0312627 A1
(43) Pub. Date: Oct. 8, 2026

(54) METHODS, ARCHITECTURES, APPARATUSES AND SYSTEMS FOR COORDINATED BEAMFORMING IN Wi-Fi

(71) Applicant: InterDigital Patent Holdings, Inc., Wilmington, DE (US)

(72) Inventors: Mahmoud Saad, L’Ile Bizard (CA); Hanqing Lou, Syosset, NY (US); Ying Wang, Easton, PA (US); Xiaofei Wang, North Caldwell, NJ (US); Rui Yang, Greenlawn, NY (US); Alphan Sahin, Columbia, SC (US)

(21) Appl. No.: 19/173,582

(22) Filed: Apr. 8, 2025

(51) Int. Cl. H04B 7/022; H04W 72/0446

(52) U.S. Cl. CPC H04B 7/022; H04W 72/0446

(57) ABSTRACT

Methods, apparatuses, and systems related to coordinated beamforming in Wi-Fi are provided. One method may include transmitting, by a first AP to a second AP, a coordinated beamforming (CoBF) invite frame to invite the second AP to participate in CoBF with the first AP, and receiving a CoBF response frame indicating an acceptance by the second AP of the CoBF with the first AP. The method may also include transmitting, to at least two STAs, an initial control frame (ICF) requesting availability information for the at least two STAs. At least one of the STAs is associated with the first AP, and at least another one of the STAs is associated with the second AP. The method may include receiving, from the at least two STAs, an initial control response frame (ICR) indicating their availability to receive coordinated transmissions from the first AP and the second AP.

### FIELD

Example embodiments described in the present disclosure are generally directed to the fields of communications, software and encoding, including, for example, to methods, architectures, apparatuses, systems related to coordinated beamforming in Wi-Fi.

### BACKGROUND

IEEE 802.11 Ultra High Reliability (UHR) explores the possibility to improve reliability, support further reduced low latency traffic, further increase peak throughput, improved power saving capabilities and improve efficiency of the IEEE 802.11 networks. Multi-AP Coordination (MAPC) is a new feature in UHR which defines several modes of coordination schemes including Coordinated Spatial Reuse (CoSR) and Coordinated Beamforming (CoBF).

### SUMMARY

Certain embodiments may be directed to a first access point (AP), which may include circuitry, such as any of a processor and transceiver. The first AP may be configured to: transmit, to a second AP, a coordinated beamforming invite frame including first information inviting the second AP to participate in coordinated beamforming with the first AP; receive, from the second AP, a coordinated beamforming response frame including second information indicating an acceptance of the coordinated beamforming with the first AP; transmit, to at least two stations (STAs), an initial control frame (ICF) including third information requesting availability information for the at least two STAs, where at least one STA of the at least two STAs is associated with the first AP and at least another STA of the at least two STAs is associated with the second AP; and receive (e.g. based on the sent ICF), from the at least two STAs, an initial control response frame (ICR) including availability acceptance information indicating availability to receive coordinated transmissions from the first AP and the second AP.

Certain embodiments may be directed to a method, which may be implemented by a first access point (AP). The method may include: transmitting, to a second AP, a coordinated beamforming invite frame including first information inviting the second AP to participate in coordinated beamforming with the first AP; receiving, from the second AP, a coordinated beamforming response frame including second information indicating an acceptance of the coordinated beamforming with the first AP; transmitting, to at least two stations (STAs), an initial control frame (ICF) including third information requesting availability information for the at least two STAs, where at least one STA of the at least two STAs is associated with the first AP and at least another STA of the at least two STAs is associated with the second AP; and receiving (e.g. based on the sent ICF), from the at least two STAs, an initial control response frame (ICR) including availability acceptance information indicating availability to receive coordinated transmissions from the first AP and the second AP.

Certain embodiments may be directed to a first access point (AP), which may include circuitry, such as any of a processor and transceiver. The first AP may be configured to: transmit, to a first station (STA) associated with the first AP, an initial control frame (ICF) including first information requesting availability information for the first STA; receive, from the first STA associated with the first AP, based on the ICF, a first initial control response frame (ICR) including availability acceptance information indicating availability to receive transmissions from the first AP; transmit, to the second AP, a coordinated beamforming invite frame including second information inviting the second AP to participate in coordinated beamforming with the first AP; receive, from the second AP, a coordinated beamforming response frame including third information indicating an acceptance of the coordinated beamforming with the first AP; and receive, from a second STA associated with the second AP, a second initial control response frame (ICR) including availability acceptance information indicating availability to receive transmissions from the second AP.

Certain embodiments may be directed to a method, which may be implemented by a first access point (AP). The method may include: transmitting, to a first station (STA) associated with the first AP, an initial control frame (ICF) including first information requesting availability information for the first STA; receiving, from the first STA associated with the first AP, based on the ICF, a first initial control response frame (ICR) including availability acceptance information indicating availability to receive transmissions from the first AP; transmitting, to the second AP, a coordinated beamforming invite frame including second information inviting the second AP to participate in coordinated beamforming with the first AP; receiving, from the second AP, a coordinated beamforming response frame including third information indicating an acceptance of the coordinated beamforming with the first AP; and receiving, from a second STA associated with the second AP, a second initial control response frame (ICR) including availability acceptance information indicating availability to receive transmissions from the second AP.

Certain embodiments may be directed to a first access point (AP), which may include circuitry, such as any of a processor and transceiver. The first AP may be configured to: transmit, to a first station (STA) associated with the first AP, an initial control frame (ICF) including first information requesting availability information for the first STA; receive, from the first STA associated with the first AP, based on the ICF, a first initial control response frame (ICR) including availability acceptance information indicating availability to receive transmissions from the first AP; transmit, to the second AP, a coordinated beamforming invite frame including second information inviting the second AP to participate in coordinated beamforming with the first AP; receive, from a second STA associated with the second AP, a second initial control response frame (ICR) including availability acceptance information indicating availability to receive transmissions from the second AP; and receive, from the second AP, a coordinated beamforming response frame including third information indicating an acceptance or a rejection of the coordinated beamforming with the first AP.

Certain embodiments may be directed to a method, which may be implemented by a first access point (AP). The method may include: transmitting, to a first station (STA) associated with the first AP, an initial control frame (ICF) including first information requesting availability information for the first STA; receiving, from the first STA associated with the first AP, based on the ICF, a first initial control response frame (ICR) including availability acceptance information indicating availability to receive transmissions from the first AP; transmitting, to the second AP, a coordinated beamforming invite frame including second information inviting the second AP to participate in coordinated beamforming with the first AP; receiving, from a second STA associated with the second AP, a second initial control response frame (ICR) including availability acceptance information indicating availability to receive transmissions from the second AP; and receiving, from the second AP, a coordinated beamforming response frame including third information indicating an acceptance or a rejection of the coordinated beamforming with the first AP.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrates a multi-access point (multi-AP) scenario for coordinating concurrent spatial streams, according to some embodiments;

FIG. 3 illustrates an example of TXOP level CoSR triggering and concurrent transmission, according to certain embodiments;

FIG. 4 illustrates an example of sequential CoBF sounding, according to some embodiments;

FIG. 5 illustrates an example of joint CoBF sounding, according to some embodiments;

FIG. 6 illustrates an example of the three subphases employed in CoBF transmission;

FIG. 7 illustrates an example of a first procedure for the availability subphase of the CoBF transmission phase, according to an embodiment;

FIG. 8 illustrates an example of a second procedure for the availability subphase of the CoBF transmission phase, according to an embodiment;

FIG. 9 illustrates an example of a third procedure for the availability subphase of the CoBF transmission phase, according to an embodiment;

FIG. 10 illustrates an example of a fourth procedure for the ACK subphase, according to an embodiment;

FIG. 11 illustrates an example of the network allocation vector (NAV) setting associated with the data transmission phase, according to some embodiments;

FIG. 12 illustrates another example of the network allocation vector (NAV) setting associated with the data transmission phase, according to some embodiments;

FIG. 13 illustrates another example of the network allocation vector (NAV) setting associated with the data transmission phase, according to some embodiments;

FIG. 14 illustrates another example of the network allocation vector (NAV) setting associated with the data transmission phase, according to some embodiments;

FIG. 15 illustrates another example of the network allocation vector (NAV) setting associated with the data transmission phase, according to some embodiments;

FIG. 16 illustrates an example flow diagram of a method, according to certain embodiments;

FIG. 17 illustrates an example flow diagram of a method, according to certain embodiments;

FIG. 18 illustrates an example flow diagram of a method, according to certain embodiments;

FIG. 19 illustrates an example flow diagram of a method, according to certain embodiments;

FIG. 20 illustrates an example flow diagram of a method, according to certain embodiments;

FIG. 21 illustrates an example flow diagram of a method, according to certain embodiments; and

FIG. 22 illustrates an example flow diagram of a method, according to certain embodiments.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

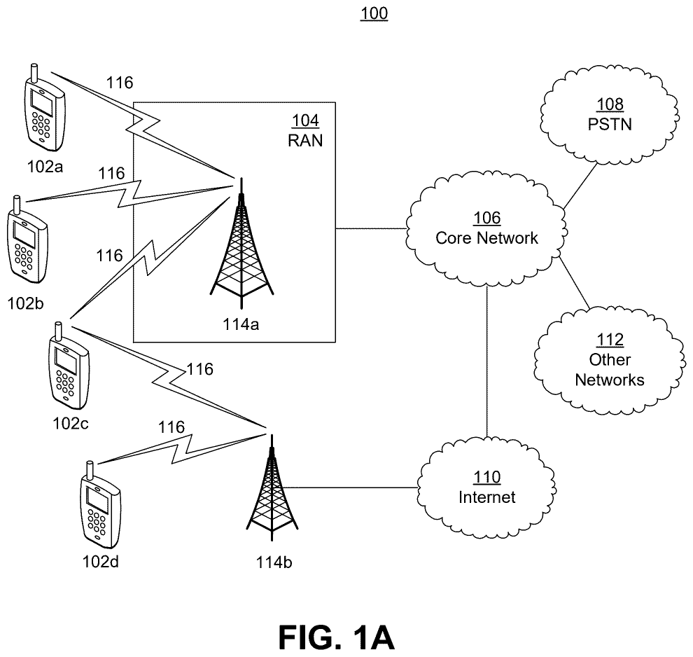

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discrete Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device (e.g. gaming device), a device operating on commercial and/or industrial wireless networks, and the like. Any of the WTRUs 102a, 102b, 102c and 102d, or any other WTRU mentioned or described herein, may be interchangeably referred to as a UE or vice versa.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing an NR radio technology, the CN 106 may also be in communication with another RAN (not shown) employing any of a GSM, UMTS, CDMA 2000, WiMAX, E-UTRA, or Wi-Fi radio technology.

The CN 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements or peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities.

Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements or peripherals 138, which may include one or more software and/or hardware modules or units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be any one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, a humidity sensor, or the like.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Although the WTRU is described in FIGS. 1A-1D as a wireless terminal, it is contemplated that in certain representative embodiments that such a terminal may use (e.g., temporarily or permanently) wired communication interfaces with the communication network. In representative embodiments, the other network 112 may be a WLAN.

A WLAN in Infrastructure Basic Service Set (BSS) mode may have an Access Point (AP) for the BSS and one or more stations (STAs) associated with the AP (e.g., See IEEE Std 802.11™-2020: Wireless LAN Medium Access Control (MAC) and Physical Layer (PHY) Specifications). The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

An AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off for a certain period of time before sensing again. One STA (e.g., only one station) may transmit at any given space, time and frequency resource in a given BSS.

In an embodiment, an AP may assign bandwidth resources over which associated STAs communicate with the AP. Bandwidth resources may include one or more channels (i.e., contiguous, or non-contiguous), one or more subchannels within a channel, one or more resource units (RUs) within an Orthogonal Frequency division Multiple Access (OFDMA) system, whereby assigned one or more RUs may be adjacent (i.e., contiguous) or non-contiguous, occupying one or more channels or subchannels, etc.

High Throughput (HT or 802.11n) STAs may use a 40 MHz wide channel for communication, for example, via a combination of the primary 20 MHz channel with an adjacent or nonadjacent 20 MHz channel to form a 40 MHz wide channel.

Very High Throughput (VHT or 802.11ac) STAs may support 20 MHz, 40 MHz, 80 MHz, and/or 160 MHz wide channels transmitted over a 5 GHz frequency band using OFDMA (e.g., See IEEE P802.11ax™/D8.0: Wireless LAN Medium Access Control (MAC) and Physical Layer (PHY) Specifications). The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

High Efficiency Wireless (HEW or 802.11ax) STAs may support 20 MHz, 40 MHz, 80 MHz, and/or 160 MHz wide channels capable of transmission over 2.4 GHz, 5 GHZ, and 6 GHz frequency bands using both OFDMA and multi-user multiple-input multiple-output (MU-MIMO) capabilities. OFDMA subcarrier modulation in HE STAs includes formats such as BPSK, QPSK, 16-QAM, 64-QAM, 256-QAM, 1024-QAM. The evolution of 802.11 to Extremely High Throughput (EHT) STAs extends to having 320 MHz wide channels.

While earlier generation 802.11 STAs (e.g., HEW or 802.11ax) could decide to transmit on one of the 2.4, 5.0, or 6 GHz bands, EHT STAs are further capable of multi-link operation (MLO), whereby data transmission between an EHT AP and non-AP STAs can occur over multiple bands simultaneously (e.g., 5 GHz and 6 GHz) thus increasing throughput and/or reliability. EHT STAs also benefit from a jump in QAM modulation from 1024-QAM to 4K-QAM, while enabling peak data rates of around 46 Gbps compared to the 9.6 Gbps capabilities of HEW STAs.

Sub 1 GHz modes of operation are supported by 802.11af and 802.11ah (e.g., See IEEE P802.11-REVme™/D5.0, Wireless LAN Medium Access Control (MAC) and Physical Layer (PHY) Specifications, February 2024). For these specifications the channel operating bandwidths, and the number of OFDM subcarriers, are reduced relative to those used in 802.11n and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. A possible use case for 802.11ah is support for Meter Type Control (MTC) devices in a macro coverage area. MTC devices may have limited capabilities with limited bandwidths, but they may require a very long battery life.

WLAN systems that support multiple channels and channel widths, such as 802.11n, 802.11ac, 802.11af, 802.11ah, 802.11ax, and 802.11be, include a channel that is designated as the primary channel. The primary channel may, but not necessarily, have a bandwidth equal to the largest common operating bandwidth supported by all STAs in the BSS. The bandwidth of the primary channel may therefore be limited by the STA that supports the smallest bandwidth operating mode in the BSS. In the example of 802.11ah, the primary channel may be 1 MHz wide if there are STAs (e.g., MTC type devices) that only support a 1 MHz mode even if the AP, and other STAs in the BSS, may support 2 MHz, 4 MHz, 8 MHz, 16 MHz, or other channel bandwidth operating modes. The carrier sensing and NAV settings depend on the status of the primary channel, i.e., if the primary channel is busy, for example, due to a STA supporting only a 1 MHz operating mode is transmitting to the AP, then the entire available frequency bands may be considered busy even though majority of it stays idle and available.

The next generation of 802.11 standard, 802.11bn (i.e., Ultra High Reliability—UHR) explores the possibility to improve reliability, support further reduced low latency traffic, further increase peak throughput, improved power saving capabilities and improve efficiency of the IEEE 802.11 network over HEW and EHT. These improvements are driven by technological advancements such as 360 immersive video, ultra-high-resolution streaming, online gaming, remote surgery, rapid expansion of Internet of Things (IoT), etc. Other 802.11 standard development examples are directed to areas such as: the application and management of artificial intelligence and machine learning (AIML) in WLANs, expanding WiFi communications into the millimeter-wave frequency band (integrated millimeter-wave—IMMW), energy harvesting based on of WiFi RF signals for facilitating WLAN communications of low-power IoT devices, and the randomization of MAC addresses in WLANs.

Embodiments disclosed herein are representative and do not limit the applicability of the apparatus, procedures, functions and/or methods to any particular wireless technology, any particular communication technology and/or other technologies. The term “network” in this disclosure may generally refer to one or more base stations, gNBs, access points, or other network entities which in turn may be associated with one or more Transmission/Reception Points (TRPs), or to any other node in the radio access network.

As introduced above, UHR explores the possibility to improve reliability, further reduce low latency traffic, further increase peak throughput, improve power saving capabilities and improve efficiency of the IEEE 802.11 networks. Multi-AP Coordination (MAPC) is a new feature in UHR which defines several modes of coordination schemes including Coordinated Spatial Reuse (CoSR) and Coordinated Beamforming (CoBF).

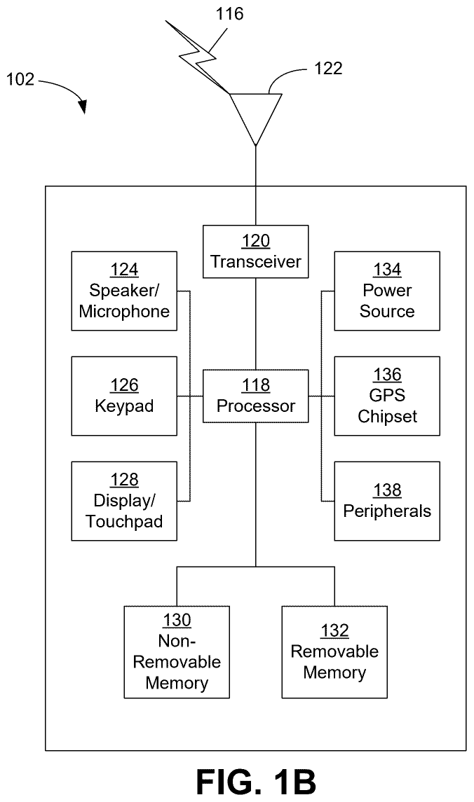

FIG. 2 illustrates a multi-access point (multi-AP) scenario for coordinating concurrent spatial streams, according to some embodiments. Accordingly, as illustrated in the example of FIG. 2, AP1 may include data for transmission to associated STA 1 and AP2 may include data for transmission to associated STA 2. In order to establish the ability for both AP1 and AP2 to spatially transmit their respective data streams concurrently (e.g., partially or completely overlapping in time), both APs may exchange communications with each other and their associated STAs according to the example embodiments described below.

802.11bn defines multi-AP Coordinated Spatial Reuse (CoSR) at transmit opportunity (TXOP)-level with power control. Its objectives include to allow more efficient medium usage by concurrent transmissions of multiple APs using transmit power control. The CoSR transmission is initiated by an AP that obtains a TXOP and becomes the initiating or sharing AP. The sharing AP transmits a Trigger frame to the participating or shared AP identified by the AP ID carried in the AID12 field of the User Info field of the Trigger frame to initiate the concurrent CoSR transmission. 802.11bn limits the concurrent CoSR transmission to the sharing AP and the shared AP (e.g., only one shared AP). A short interval after the Trigger Frame, the two APs may simultaneously start to transmit their respective data physical layer protocol data units (PPDUs) during the concurrent CoSR transmission. The duration of the two ensuing data PPDUs are the same as well. In addition, 802.11bn limits both data PPDUs to be downlink (DL) single-user (SU) PPDUs and the maximum number of spatial streams transmitted by each AP in CoSR to 4. Moreover, 802.11bn defines two modes for the concurrent CoSR transmission. In Mode 1, at least one of the two data PPDUs during the concurrent CoSR transmission could be an EHT PPDU. The format of the two data PPDUs could be a combination of UHR+EHT, EHT+UHR, or EHT+EHT. Both PPDUs have the same non-high-throughput signal field (e.g., legacy signal (L-SIG)) content. In Mode 2, both data PPDUs are UHR PPDUs that have the same L-SIG and universal signal field (U-SIG) contents. Also, in Mode 2, the short interval between the end of the Trigger Frame and the two concurrent UHR data PPDUs is short interframe space (SIFS).

It is noted that, as used herein, a “sharing AP” may refer to an AP that has acquired a TXOP and is willing or able to share it with one or more APs using a certain coordination scheme (e.g., CoBF). Further, as used herein, a “shared AP” may refer to an AP that is invited or requested to share a TXOP with another AP (e.g., sharing AP).

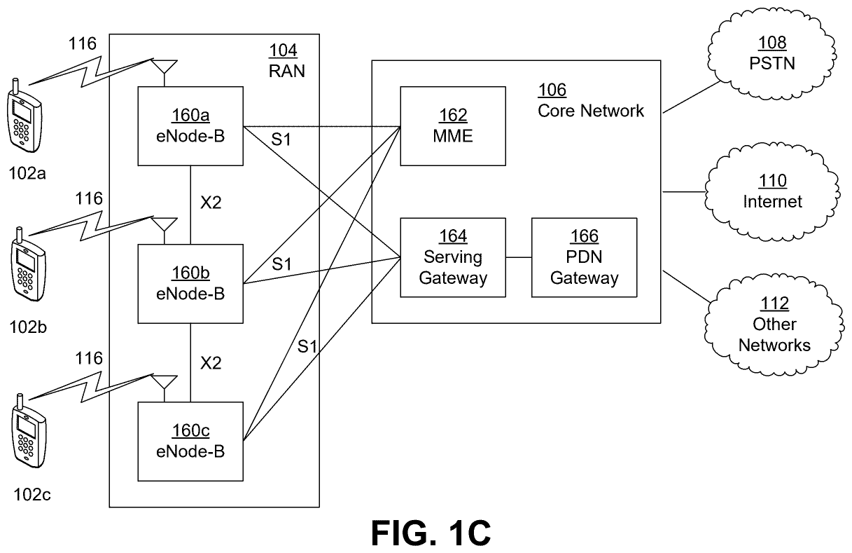

FIG. 3 illustrates an example of TXOP level CoSR triggering and concurrent transmission, according to certain embodiments. As illustrated in the example of FIG. 3, the CoSR transmission may be initiated by AP1 that obtains a TXOP and becomes the initiating AP or the sharing AP. To initiate CoSR transmission, the sharing AP1 may transmit a CoSR Trigger frame to the shared AP2, which may be identified by the AP ID carried in the AID12 field of the User Info field of the Trigger frame. AP1 and AP2 may then transmit their respect DL PPDUs to STA1 or STA2.

802.11bn has defined coordinated beamforming (CoBF) as a technique which can be used by multiple APs, each with multiple antennas (e.g., acting as a beamformer), to steer signals using knowledge of the channel in order to improve throughput, improve reliability, and/or to reduce latency. An objective of CoBF is to allow more efficient medium usage by enabling concurrent transmissions of two APs with multiple antennas to each AP's associated STAs while minimizing interference to overlapping basic service set (OBSS) STAs by using the channel state information (CSI) of the channels between each AP and the recipient STAs of the other AP of the CoBF transmission. Under the current definition of CoBF, the number of participating APs in a CoBF transmission is 2 with a maximum of 4 recipient STAs across the two APs, the maximum number of spatial streams per recipient STA in CoBF is 2, and the maximum number of spatial streams across the two APs participating in CoBF is limited to 4. However, it should be noted that example embodiments described herein are not limited to these number of APs, STAs, and/or spatial streams.

In SU-MIMO beamforming, the spatial streams (e.g., all spatial streams) in the transmitted signal are intended for reception at a single STA; while in DL MU-MIMO beamforming, disjoint subsets of the spatial streams are transmitted from a single AP and are intended for reception at different non-AP STAs. Differently, in CoBF, disjoint subsets of spatial streams are transmitted from different APs, where each AP's subset of streams may be further divided into the streams intended for reception at one or more non-AP STAs associated with that AP.

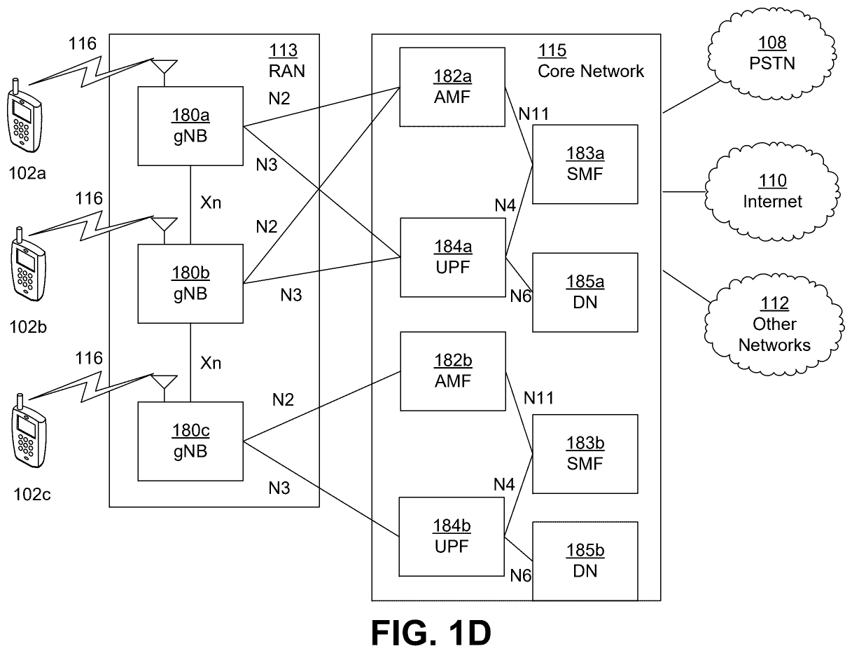

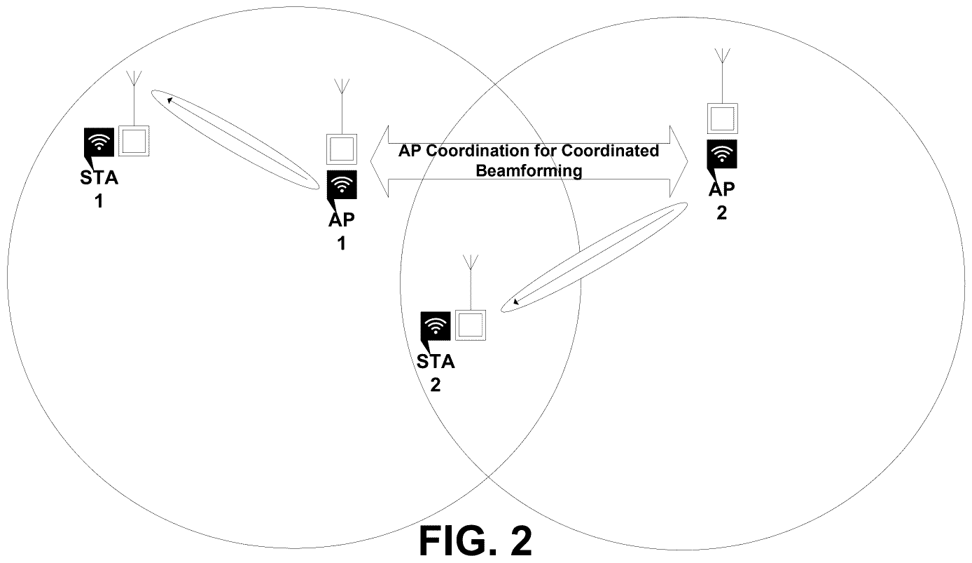

CoBF may be performed in two phases. Namely, a CoBF sounding phase and a CoBF data transmission phase. The CoBF sounding phase may be performed frequently (e.g., every 50 ms) while the CoBF data transmission phase may be performed by the sharing AP when it acquires the TXOP. Two CoBF sounding schemes are supported in UHR: sequential CoBF Sounding (e.g., see FIG. 4) and joint CoBF Sounding (e.g., see FIG. 5). FIG. 4 illustrates an example of sequential CoBF sounding, according to some embodiments. As illustrated in the example of FIG. 4, AP1 may initiate UHR TB sequential NDP sounding sequence. FIG. 5 illustrates an example of joint CoBF sounding, according to some embodiments. In the example of FIG. 5, AP1 may initiate UHR TB joint NDP sounding sequence. In both schemes (e.g., in FIG. 4 and FIG. 5), the same sequence initiated by AP1 is later initiated by AP2 subsequently after a SIFS.

Both sharing and shared APs may need to guarantee or determine the availability of their associated STAs participating in the CoBF transmission phase. For example, the APs may need to determine the availability of their associated STAs before sending information to synchronize CoBF, e.g., before sending a CoBF Sync Trigger frame. Further, the sharing and shared APs may need to protect the TXOP starting at the CoBF Invite and extending to the ACK of the reception of the PPDUs. An efficient and robust procedure to guarantee the availability of the STAs and to protect the TXOP is currently lacking in Wi-Fi. Certain embodiments described herein may address at least these issues and thereby provide improvements and/or enhancements at least to CoBF in Wi-Fi.

As will be discussed in more detail below, some embodiments described herein can provide a set of approaches to shorten the frame exchange sequence in the CoBF transmission phase, e.g., to deliver better efficiency and to further improve the robustness of the procedure.

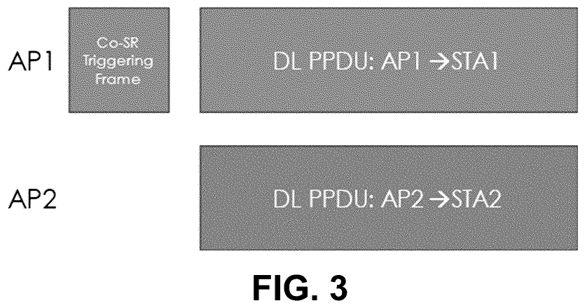

Certain embodiments may include procedures for enhancing a transmission phase in coordinated transmission schemes, such as CoBF or CoSR. The transmission phase in coordinated transmission schemes, such as CoBF and CoSR, can be divided into three subphases, the availability subphase, the transmission subphase, and the acknowledgement or ACK subphase, as illustrated in the example of FIG. 6 discussed below. In the availability subphase, the sharing AP may invite the shared AP for coordinated transmission (e.g., CoBF) to check its availability for the coordinated transmission. Further, the sharing AP and shared AP (e.g., both the sharing and shared AP) may poll their selected STAs to participate in the coordinated transmission. In the data transmission subphase, the sharing AP may trigger the concurrent PPDU transmission of both the sharing AP and the shared AP. Finally, in the ACK subphase, both the sharing AP and the shared AP may solicit the ACK from their respective STAs which participated in the coordinated transmission (e.g., CoBF).

FIG. 6 depicts an example of the three subphases employed in CoBF transmission. That is, FIG. 6 illustrates an example frame exchange sequence of the transmission phase in CoBF. As illustrated in the example of FIG. 6, in the availability subphase, AP1 (e.g., sharing AP) sends a CoBF Invite frame to AP2 (e.g., shared AP). AP2 may respond with a CoBF Response frame, e.g., with a status code to indicate whether it accepts or rejects the invitation. If AP2 is available and accepts the invitation, AP1 may send an Initial Control Frame (ICF) to its STAs, e.g., STA1. If STA1 is available, it may respond with an Initial Control Response frame (ICR) to AP1. Then, AP2 may send an Initial Control Frame (ICF) to its STAs, e.g., STA2. If STA2 is available, it may respond with an Initial Control Response frame (ICR) to AP2. In the data transmission subphase, AP1 (e.g., the sharing AP) may send a CoBF Sync Trigger frame to synchronize the coordinated beamformed data transmission from AP1 to STA1 while nulling towards STA2 and from AP2 to STA2 while nulling towards STA1. Finally, in the ACK subphase, AP1 may send a Multi-User Block ACK Request (MU-BAR) to its STAs (e.g., STA1) to solicit a Block ACK response (BA) and AP2 sends a Multi-User Block ACK Request (MU-BAR) to its STAs (e.g., STA2) to solicit a Block ACK response (BA).

The frame exchange sequence illustrated in the example of FIG. 6 is a prolonged sequence and prone to failures. Certain embodiments provide a set of approaches or alternatives to shorten the sequence for better efficiency and/or to further improve the robustness of the procedure. Notably, a set of different approaches or alternatives are devised for each of the three subphases which can be combined in the same sequential order. In other words, any alternative of the availability subphase can be followed by any alternative of the data transmission subphase which in turn can be followed with any alternative of the ACK subphase.

The approaches proposed for each of the three subphases illustrated in the example of FIG. 6 discussed above can be combined in the same or different order. In other words, one alternative of the availability subphase in the first order can be combined with one alternative of the data transmission subphase in the second order which in turn can be combined with one alternative of the ACK subphase in the third order.

In general, according to certain embodiments described herein, the provided approaches for the three subphases (of a transmission phase) may include or consider different ordering for the individual frames sent within the subphase and/or different set of information exchanged in the frames to facilitate the efficient and robust operation of the CoBF transmission.

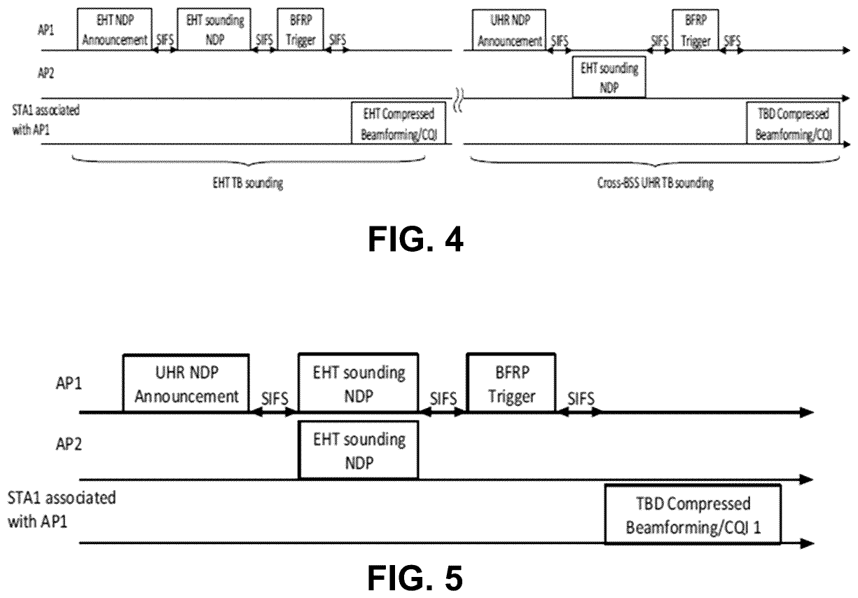

FIG. 7 illustrates an example of a first procedure for the availability subphase of the CoBF transmission phase, according to an embodiment. In other words, FIG. 7 illustrates an example of an enhanced frame exchange sequence of the transmission phase in CoBF, according to an embodiment. In this procedure, AP1 (e.g., sharing AP) may poll its STAs (e.g., STA1 in this example) by transmitting an ICF to check the availability of the STAs. If STA1 is available, it may respond with an ICR. Subsequently, AP1 may send a CoBF Invite frame to invite AP2 (e.g., shared AP) for the CoBF transmission. AP2 may then respond with a CoBF Response frame to accept the invitation and to indicate its availability for the CoBF transmission. Then, AP2 may poll its STAs (e.g., STA2) by sending an ICF frame and if STA2 is available, it responds with ICR frame.

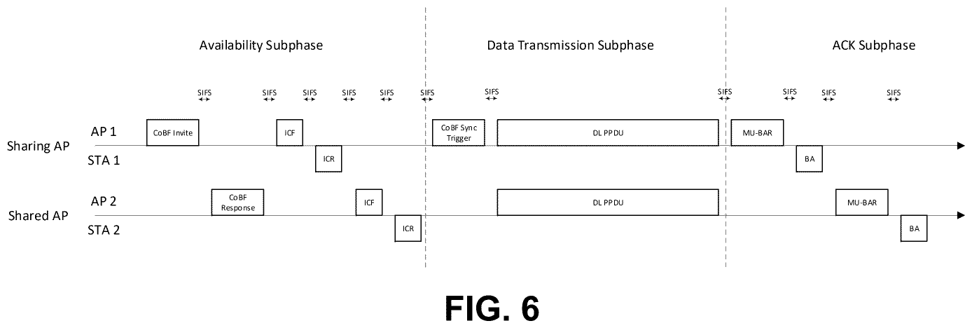

FIG. 8 illustrates an example of a second procedure for the availability subphase of the CoBF transmission phase, according to an embodiment. That is, FIG. 8 illustrates an example of an enhanced frame exchange sequence of the transmission phase in CoBF, according to an embodiment. As illustrated in the example of FIG. 8, in this procedure, AP1 (e.g., sharing AP) may poll its STAs (e.g., STA1 in this example) by transmitting an ICF to check the availability of the STAs. If STA1 is available, it may respond with an ICR. Subsequently, AP1 may send the CoBF Invite frame to invite AP2 (e.g., shared AP) for the CoBF transmission. Then, AP2 may poll its own STAs (e.g. STA2) to check its availability by sending an ICF. If STA2 is available it may respond with an ICR. AP2 may then send a CoBF Response, e.g., with accept status to accept the invitation if its STAs are available for the coordinated transmission or may send a CoBF Response, e.g., with reject status to reject the invitation if its STAs are unavailable for the coordinated transmission.

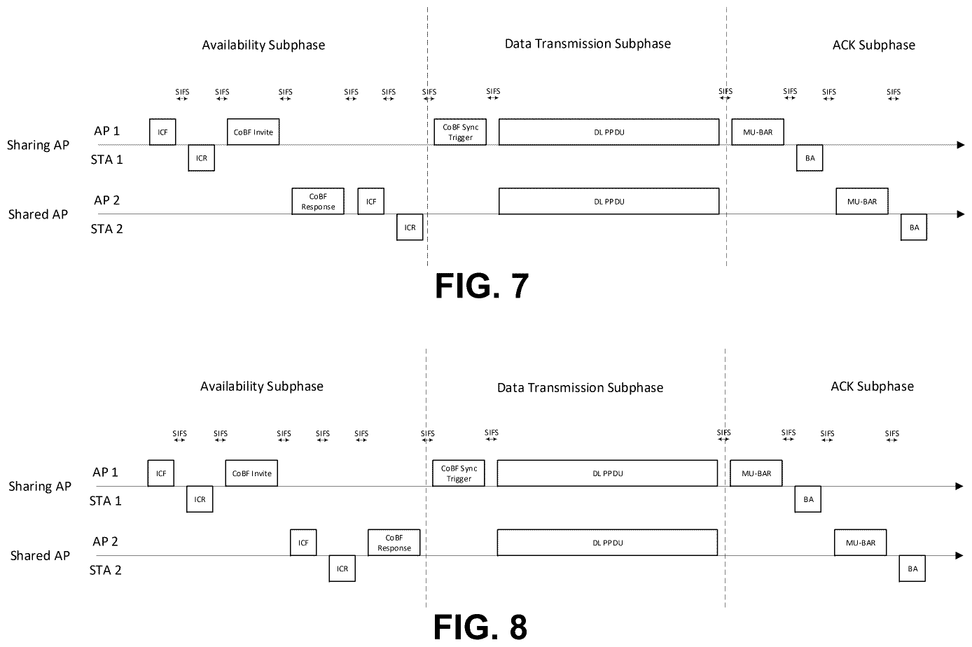

FIG. 9 illustrates an example of a third procedure for the availability subphase of the CoBF transmission phase, according to an embodiment. In other words, FIG. 9 illustrates an example of an enhanced frame exchange sequence of the transmission phase in CoBF, according to an embodiment. As illustrated in the example of FIG. 9, in this procedure, AP1 (e.g., sharing AP) may send a CoBF Invite frame to AP2 (e.g., shared AP). AP2 may respond with a CoBF Response frame, e.g., with a status code to indicate whether it accepts or rejects the invitation. If AP2 is available and accepts the invitation, both AP1 and AP2 may concurrently send ICF frames to their respective STAs (i.e., AP1 to STA1 and AP2 to STA2). If STA1 is available, it may respond with an ICR to AP1. Similarly, if STA2 is available it may respond with an ICR to AP2. STA1 and STA2 may be allocated orthogonal resources in the respective ICF frames to send the ICR frames. AP1 and AP2 may use orthogonal resources to send the concurrent ICF frames as well. In some embodiments, the allocation of the orthogonal resources may be signaled in the CoBF Invite frame or may be agreed beforehand during the CoBF MAPC forming stage that sets up the MAPC group of APs for CoBF.

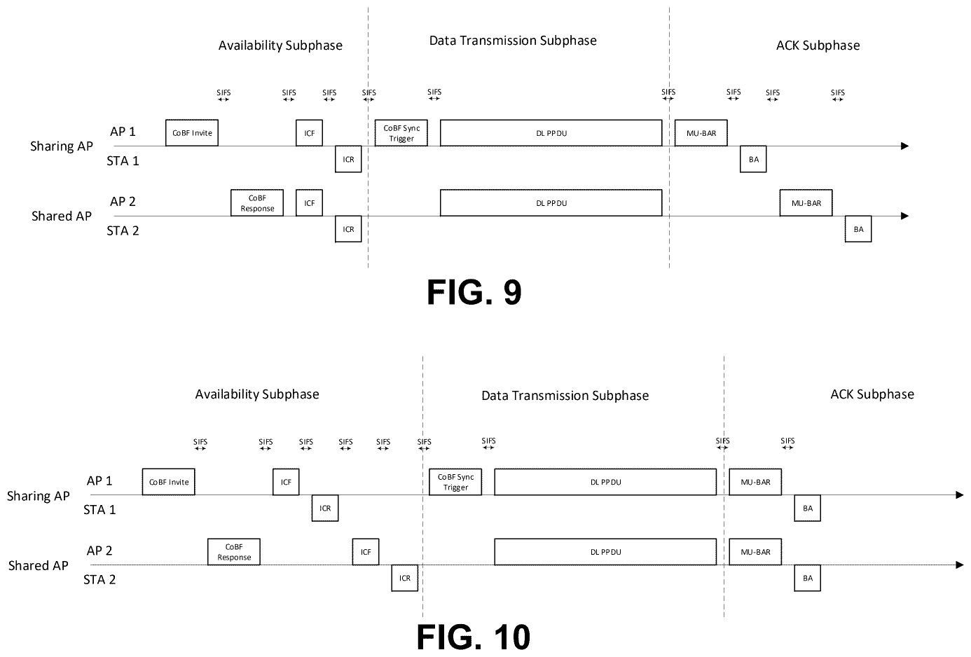

FIG. 10 illustrates an example of a fourth procedure for the ACK subphase, according to an embodiment. That is, FIG. 10 illustrates an example of an enhanced frame exchange sequence of the transmission phase in CoBF, according to an embodiment. As illustrated in the example of FIG. 10, in this procedure, AP1 and AP2 may send two identical MU-BAR trigger frames concurrently on the same resources which allocate orthogonal resources for STA1 and STA2 to send their BA responses. In another embodiment, AP1 and AP2 may send two MU-BAR trigger frames concurrently using orthogonal resources that may be allocated by AP1 in the CoBF Sync Trigger frame.

It should be noted that, according to certain embodiments, it is contemplated that any of the procedures or sequences illustrated in the examples of FIGS. 7-10 may be combined or re-ordered in any suitable manner.

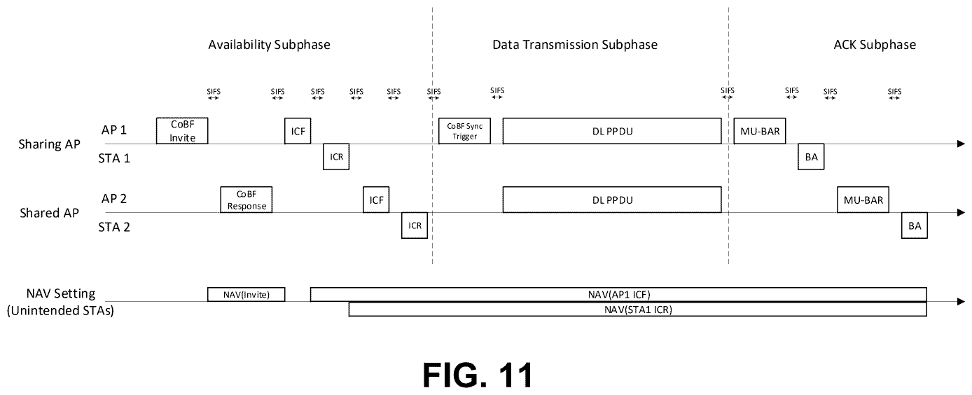

FIG. 11 illustrates an example of the network allocation vector (NAV) setting associated with the data transmission phase, according to some embodiments. In an embodiment, the NAV setting by the unintended STAs may follow the illustration in the example of FIG. 11. The unintended STAs may include all STAs associated with AP1, AP2 or any other OBSS, but does not include STAs that are selected to participate in the CoBF transmission phase from AP1 (e.g., STA1) and from AP2 (e.g., STA2). For example, STA1 and STA2 may know that they are selected for the CoBF transmission phase based on any of the following occasions: (1) STA1 and STA2 are included in the CoBF sounding phase, thus they expect they are potential candidates for a CoBF transmission that may follow; (2) STA1 is addressed in the CoBF Invite frame initiating the CoBF transmission phase and STA2 is addressed in the CoBF Response frame responding to the CoBF transmission invitation; and/or (3) STA1 receives an ICF from AP1 and STA2 receives an ICF from AP2.

In an embodiment, the duration information in the frames sent in the procedure illustrated in the example of FIG. 11 may consider any of the following:

$$Duration ( Invite ) = CoBFResponseTime + 2 aSIFSTime ,$$

$$Duration ( AP 1 ICF ) = 2 ICRTime + ICFTime + CoBFSyncTriggerTime + DLPPDUTime + 2 MUBARTime + 2 BATime + 9 aSIFSTime ,$$

$$Duration ( STA 1 ICR ) = Duration ( AP 1 ICF ) - ICRTime - aSIFSTime ,$$

$$Duration ( AP 2 ICF ) = Duration ( AP 1 ICF ) - ICRTime - ICFTime - 2 aSIFSTime ,$$

$$Duration ( STA 2 ICR ) = Duration ( AP 2 ICF ) - ICRTime - aSIFSTime .$$

In other words, according to certain embodiments, the duration associated with the invite may be based on the CoBF response time and SIFS time. The duration associated with the ICF from AP1 may be based on the ICR time, ICF time, CoBF synchronization trigger time, DL PPDU time, MU-BAR time, BA time, and SIFS time. The duration associated with the ICR from STA1 may be based on the duration of the ICF from AP1, the ICR time, and the SIFS time. The duration associated with the ICF from AP2 may be based on the duration of the ICF from AP1, the ICR time, the ICF time, and the SIFS time. The duration of the ICR from STA2 may be based on the duration of the ICF from AP2, the ICR time, and the SIFS time.

In an embodiment, AP2 and STA2, as well as STA1, may ignore the NAV setting based on the indications in FIG. 11 and may not go into a doze mode during the frame exchange of the CoBF transmission phase.

In an embodiment, the sharing AP and shared AP may disallow the STAs that are selected to participate in the CoBF transmission phase from entering the power save mode thereby disallowing theses STAs from going into the doze mode. This way, the STAs may be available for the CoBF data transmission.

In an embodiment, the sharing AP may discontinue the CoBF transmission phase procedure if it did not receive the CoBF Response or if the shared AP sent the CoBF Response indicating a rejection, e.g., with a decline (e.g., reject) status code. In some embodiments, the sharing AP may also discontinue the CoBF transmission phase procedure if the ICR of STA1 or the ICR of STA2 are not received. In this case, for example, the sharing AP (which is also the TXOP owner) may resume transmission to its associated STAs in a non-coordinated manner or in a coordinated manner with other APs.

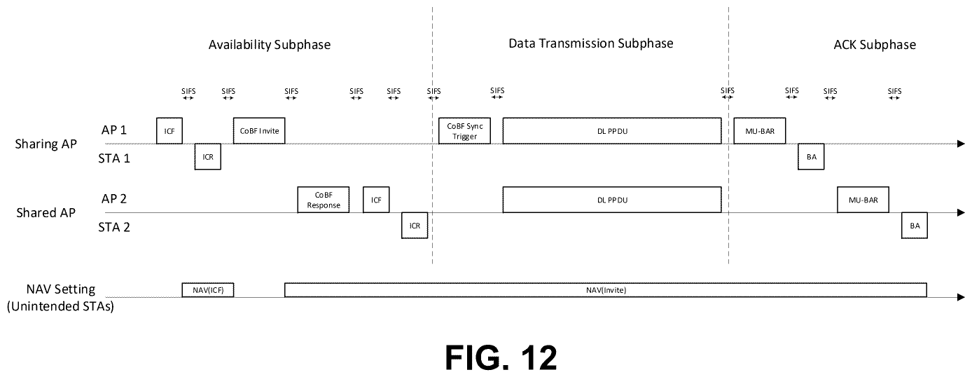

FIG. 12 illustrates another example of the network allocation vector (NAV) setting associated with the data transmission phase, according to some embodiments. In an embodiment, the NAV setting by the unintended STAs may follow the illustration depicted in the example of FIG. 12. The unintended STAs may include all STAs from AP1's BSS, AP2's BSS, or any other OBSS, but does not include STAs that are selected to participate in the CoBF transmission phase from AP1 (e.g., STA1) and from AP2 (e.g., STA2). For example, STA1 and STA2 may know that they are selected for the CoBF transmission phase based on any of the following occasions: (1) STA1 and STA2 are included in the CoBF sounding phase, thus they expect they are potential candidates for a CoBF transmission that may follow; (2) STA1 is addressed in the CoBF Invite frame initiating the CoBF transmission phase and STA2 is addressed in the CoBF Response frame responding to the CoBF transmission invitation; and/or (3) STA1 receives an ICF from AP1 and STA2 receives an ICF from AP2.

In an embodiment, the duration information in the frames sent in the procedure illustrated in the example of FIG. 12 may consider any of the following:

$$Duration ( ICF ) = ICRTime + 2 aSIFSTime ,$$

$$Duration ( Invite ) = CoBFResponseTime + ICFTime + ICRTime + CoBFSyncTriggerTime + DLPPDUTime + 2 MUBARTime + 2 BATime + 9 aSIFSTime ,$$

$$Duration ( AP 2 ICF ) = Duration ( Invite ) - CoBFResponseTime - ICFTime - 2 aSIFSTime ,$$

$$Duration ( STA 2 ICR ) = Duration ( AP 2 ICF ) - ICRTime - aSIFSTime .$$

In other words, according to certain embodiments, the duration associated with the ICF may be based on the ICR time and SIFS time. The duration associated with the invite may be based on the CoBF response time, ICF time, ICR time, CoBF synchronization trigger time, DL PPDU time, MU-BAR time, BA time, and SIFS time. The duration associated with the ICF from AP2 may be based on the duration associated with the invite, CoBF response time, ICF time, and SIFS time. The duration associated with the ICR from STA2 may be based on the duration of the ICF from AP2, the ICR time, and the SIFS time.

In an embodiment, AP2 and STA2, and STA1 may ignore the NAV setting based on the indications in the example of FIG. 12, and may not go in a doze mode during the frame exchange of the CoBF transmission phase.

In an embodiment, the sharing AP and shared AP may disallow the STAs that are selected to participate in the CoBF transmission phase from entering the power save mode thereby disallowing theses STAs from going into the doze mode. This way, the STAs may be available for the CoBF data transmission.

In an embodiment, the sharing AP may discontinue the CoBF transmission phase procedure if it did not receive the ICR of STA1, the CoBF Response, and/or if the shared AP sent the CoBF Response rejecting CoBF, e.g., with a decline (reject) status code. In some embodiments, the sharing AP may also discontinue the CoBF transmission phase procedure if the ICR of STA2 is not received. In an embodiment, the sharing AP (which is also the TXOP owner) may resume transmission to its associated STAs in a non-coordinated manner or in a coordinated manner with other APs.

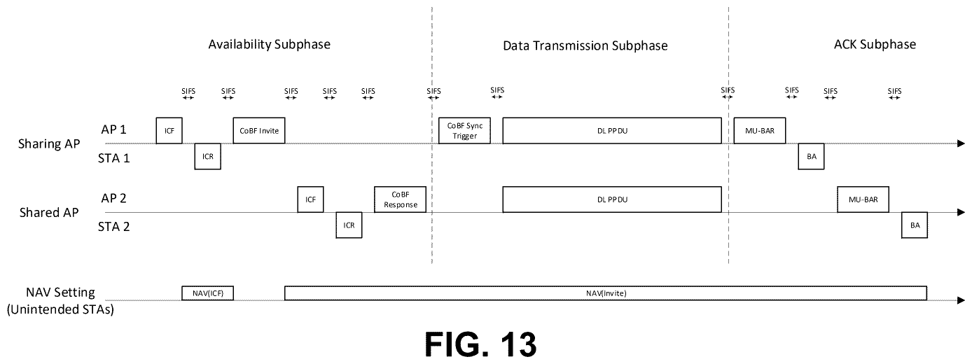

FIG. 13 illustrates another example of the network allocation vector (NAV) setting associated with the data transmission phase, according to some embodiments. In an embodiment, the NAV setting by the unintended STAs may follow the illustration in the example of FIG. 13. The unintended STAs may include all STAs from AP1's BSS, AP2's BSS, or any other OBSS, but does not include STAs that are selected to participate in the CoBF transmission phase from AP1 (e.g., STA1) and from AP2 (e.g., STA2). For example, STA1 and STA2 may know that they are selected for the CoBF transmission phase based on any of the following occasions: (1) STA1 and STA2 are included in the CoBF sounding phase, thus they expect they are potential candidates for a CoBF transmission that may follow; (2) STA1 is addressed in the CoBF Invite frame initiating the CoBF transmission phase and STA2 is addressed in the CoBF Response frame responding to the CoBF transmission invitation; and/or (3) STA1 receives an ICF from AP1 and STA2 receives an ICF from AP2.

In an embodiment, the duration information in the frames sent in the procedure illustrated in the example of FIG. 13 may consider any of the following:

$$Duration ( ICF ) = ICRTime + 2 aSIFSTime ,$$

$$Duration ( Invite ) = CoBFResponseTime + ICFTime + ICRTime + CoBFSyncTriggerTime + DLPPDUTime + 2 MUBARTime + 2 BATime + 9 aSIFSTime ,$$

$$Duration ( AP 2 ICF ) = Duration ( Invite ) - ICFTime - aSIFSTime ,$$

$$Duration ( STA 2 ICR ) = Duration ( AP 2 ICF ) - ICRTime - aSIFSTime .$$

In other words, according to certain embodiments, the duration associated with the ICF may be based on the ICR time and SIFS time. The duration associated with the invite may be based on the CoBF response time, ICF time, ICR time, CoBF synchronization trigger time, DL PPDU time, MU-BAR time, BA time, and SIFS time. The duration associated with the ICF from AP2 may be based on the duration associated with the invite, ICF time, and SIFS time. The duration associated with the ICR from STA2 may be based on the duration of the ICF from AP2, the ICR time, and the SIFS time.

In one embodiment, AP2 and STA2, and STA1 may ignore the NAV setting based on the indications in the example of FIG. 13 and may not go in a doze mode during the frame exchange of the CoBF transmission phase.

In an embodiment, the sharing AP and shared AP may disallow the STAs that are selected to participate in the CoBF transmission phase entering the power save mode thereby disallowing theses STAs from going into the doze mode. This way, the STAs may be available for the CoBF data transmission.

In an embodiment, the sharing AP may discontinue the CoBF transmission phase procedure if it did not receive the ICR of STA1, the ICR of STA2, the CoBF Response, and/or if the shared AP sent the CoBF Response indicating a rejection, e.g., with a decline (reject) status code. According to certain embodiments, the sharing AP (which is also the TXOP owner) may resume transmission to its associated STAs in a non-coordinated manner or in a coordinated manner with other APs.

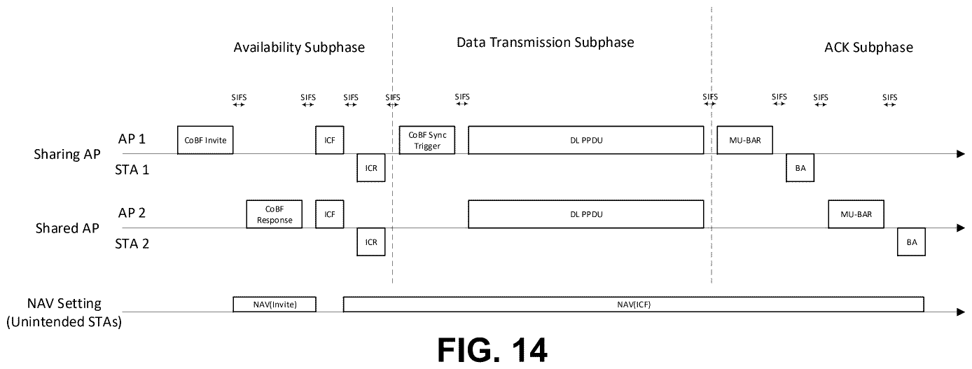

FIG. 14 illustrates another example of the network allocation vector (NAV) setting associated with the data transmission phase, according to some embodiments. In an embodiment, the NAV setting by the unintended STAs may follow the illustration in the example of FIG. 14. The unintended STAs may include all STAs from AP1's BSS, AP2's BSS, or any other OBSS, but does not include STAs that are selected to participate in the CoBF transmission phase from AP1 (e.g., STA1) and from AP2 (e.g., STA2). For example, STA1 and STA2 may know that they are selected for the CoBF transmission phase based on any of the following occasions: (1) STA1 and STA2 are included in the CoBF sounding phase, thus they expect they are potential candidates for a CoBF transmission that may follow; (2) STA1 is addressed in the CoBF Invite frame initiating the CoBF transmission phase and STA2 is addressed in the CoBF Response frame responding to the CoBF transmission invitation; and/or (3) STA1 receives an ICF from AP1 and STA2 receives an ICF from AP2.

In an embodiment, the duration information in the frames sent in the procedure illustrated in the example of FIG. 14 may consider any of the following:

$$Duration ( Invite ) = CoBFResponseTime + 2 aSIFSTime ,$$

$$Duration ( AP 1 ICF ) = ICRTime + CoBFSyncTriggerTime + DLPPDUTime + 2 MUBARTime + 2 BATime + 7 aSIFSTime ,$$

$$Duration ( AP 2 ICF ) = Duration ( AP 1 ICF ) ,$$

$$Duration ( STA 2 ICR ) = Duration ( STA 2 ICF ) - ICFTime - aSIFSTime .$$

In other words, according to certain embodiments, the duration associated with the invite may be based on the CoBF response time and SIFS time. The duration associated with the ICF from AP1 may be based on the ICR time, CoBF synchronization trigger time, the DL PPDU time, the MU-BAR time, BA time, and SIFS time. The duration associated with the ICF from AP2 may be based on the duration associated with the ICF from AP1. The duration associated with the ICR from STA2 may be based on the duration of the ICF from AP2, the ICR time, and the SIFS time.

In an embodiment, AP2 and STA2, as well as STA1, may ignore the NAV setting based on the indications in the example of FIG. 14 and may not go in a doze mode during the frame exchange of the CoBF transmission phase.

In an embodiment, the sharing AP and shared AP may disallow the STAs that are selected to participate in the CoBF transmission phase entering the power save mode thereby disallowing theses STAs from going into the doze mode. This way, the STAs may be available for the CoBF data transmission.

In an embodiment, the sharing AP may discontinue the CoBF transmission phase procedure if it did not receive the CoBF Response or if the shared AP sent the CoBF Response indicating a rejection, e.g., with a decline (reject) status code. According to an embodiment, the sharing AP may also discontinue the CoBF transmission phase procedure if it did not receive the ICR of STA1 and/or the ICR of STA2. In some embodiments, the sharing AP (which is also the TXOP owner) may resume transmission to its associated STAs in a non-coordinated manner or in a coordinated manner with other APs.

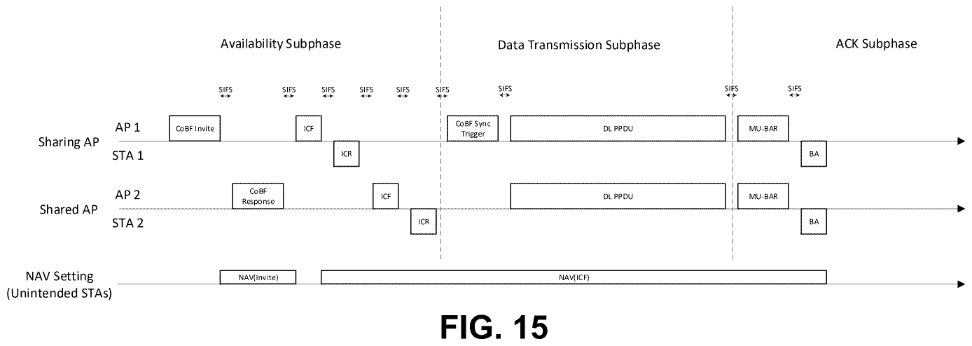

FIG. 15 illustrates another example of the network allocation vector (NAV) setting associated with the data transmission phase, according to some embodiments. In an embodiment, the NAV setting by the unintended STAs may follow the illustration in the example of FIG. 15. The unintended STAs may include all STAs from AP1's BSS, AP2's BSS, or any other OBSS, but does not include STAs that are selected to participate in the CoBF transmission phase from AP1 (e.g., STA1) and from AP2 (e.g., STA2). For example, STA1 and STA2 may know that they are selected for the CoBF transmission phase based on any of the following occasions: (1) STA1 and STA2 are included in the CoBF sounding phase, thus they expect they are potential candidates for a CoBF transmission that may follow; (2) STA1 is addressed in the CoBF Invite frame initiating the CoBF transmission phase and STA2 is addressed in the CoBF Response frame responding to the CoBF transmission invitation; and/or (3) STA1 receives an ICF from AP1 and STA2 receives an ICF from AP2.

In an embodiment, the duration information in the frames sent in the procedure illustrated in the example of FIG. 15 may consider any of the following:

$$Duration ( Invite ) = CoBFResponseTime + 2 aSIFSTime ,$$

$$Duration ( AP 1 ICF ) = 2 ICRTime + ICFTime + CoBFSyncTriggerTime + DLPPDUTime + MUBARTime + BATime + 7 aSIFSTime ,$$

$$Duration ( AP 2 ICF ) = Duration ( AP 1 ICF ) - ICRTime - 2 aSIFSTime ,$$

$$Duration ( STA 2 ICR ) = Duration ( STA 2 ICF ) - ICFTime - aSIFSTime .$$

In other words, according to certain embodiments, the duration associated with the invite may be based on the CoBF response time and SIFS time. The duration associated with the ICF from AP1 may be based on the ICR time, ICF time, CoBF synchronization trigger time, DL PPDU time, MU-BAR time, BA time, and SIFS time. The duration associated with the ICF from AP2 may be based on the duration associated with the ICF from AP1, the ICR time, and the SIFS time. The duration associated with the ICR from STA2 may be based on the duration of the ICF from AP2, the ICF time, and the SIFS time.

In an embodiment, AP2 and STA2, and STA1 may ignore the NAV setting based on the indications in the example of FIG. 15 and may not go in a doze mode during the frame exchange of the CoBF transmission phase.

In an embodiment, the sharing AP and shared AP may disallow the STAs that are selected to participate in the CoBF transmission phase entering the power save mode thereby disallowing theses STAs from going into the doze mode. This way, the STAs may be available for the CoBF data transmission.

In an embodiment, the sharing AP may discontinue the CoBF transmission phase procedure if it did not receive the CoBF Response or if the shared AP sent the CoBF Response indicating a rejection, e.g., with a decline (reject) status code. According to an embodiment, the sharing AP may also discontinue the CoBF transmission phase procedure if it did not receive the ICR of STA1 and/or the ICR of STA2. In some embodiments, the sharing AP (which is also the TXOP owner) may resume transmission to its associated STAs in a non-coordinated manner or in a coordinated manner with other APs.

As introduced above, certain embodiments may include signaling in or associated with a CoBF invite. In an embodiment, the sharing AP may indicate in the CoBF Invite frame the necessary information required to manage the concurrent transmission of the ICF in both the sharing AP and the shared AP, as illustrated in the example of FIG. 9 introduced above.

According to an embodiment, an identical ICF may be transmitted by both AP1 and AP2 which includes User Info fields for all participating STAs from AP1 (e.g., STA1) and AP2 (e.g., STA2). The identical ICF may be transmitted at substantially the same time (e.g., the exact same time) in both BSS1 of the sharing AP and BSS2 of the shared AP. In an embodiment, the order of the User Info fields in the ICF may include the User Info fields from AP1 followed by the User Info fields from AP2. The User Info fields of the same AP may be ordered in terms of the number of spatial streams allocated to each of them with the STA allocated the largest number of spatial streams being first in the order.

In some embodiments, the resources allocated to each of the STAs from AP1 and AP2 to send the ICR may be orthogonal in the frequency domain or the spatial domain and may be determined following a set of rules such that both AP1 and AP2 may form identical allocations to the STAs and thus the ICF frame may be identical in both APs. The set of rules for the resource allocation may include any of: (1) the STAs are allocated frequency resources from lowest frequency to highest frequency based on the order and the number of the User Info fields in the ICF frame; (2) the punctured channels may not be considered in the allocation of the resources for the STAs to send their ICR and/or both sharing AP and shared AP may have the same puncturing pattern in the common channel width which will be used for CoBF transmission; and/or (3) the modulation and coding scheme (MCS) to transmit the ICR is fixed to a value ICR-MCS which may be statically defined such as MCSO, e.g., determined by a field in the CoBF Invite frame or determined by a field which is negotiated in the Multi-AP Coordination (MAPC) agreement.

Table 1 below illustrates an example of STAs being allocated frequency resources from lowest frequency to highest frequency based on the order and the number of the User Info fields in the ICF frame. More specifically, Table 1 shows an example listing of the sizes of the allocated resources indicated in the ICF, where the allocated resources may be used by the STAs to send the ICR. For example, if the ICF includes an indication of an uplink bandwidth in the common field, a special user info field, or any other field in the trigger frame (i.e., the ICF frame) of 20 MHz: (i) if the number of User Info fields is larger than 4 but less than or equal to 9, then each STA is allocated a 26-tone RU; (ii) if the number of User Info fields is 3 or 4, each STA is allocated a 52-tone RU; (iii) if the number of User Info fields is 2, each STA is allocated a 106-tone RU. For example, if the ICF includes an indication of an uplink bandwidth in the common field, a special user info field, or any other field in the trigger frame (i.e., the ICF frame) of 40 MHz: (i) if the number of User Info fields is larger than 8, each STA is allocated a 26-tone RU; (ii) if the number of User Info fields between 5 and 8, each STA is allocated a 52-tone RU; (iii) if the number of User Info fields is 3 or 4, each STA is allocated a 106-tone RU; (iv) if the number of User Info fields is 2, each STA is allocated a 242-tone RU. For example, if the ICF includes an indication of an uplink bandwidth in the common field, a special user info field, or any other field in the trigger frame (i.e., the ICF frame) of 80 MHz: (i) if the number of User Info fields is larger than 8, each STA is allocated a 52-tone RU; (ii) if the number of User Info fields is between 5 and 8, each STA is allocated a 106-tone RU; (iii) if the number of User Info fields is 3 or 4, each STA is allocated a 242-tone RU; (iv) if the number of User Info fields is 2, each STA is allocated a 484-tone RU. For example, if the ICF includes an indication of an uplink bandwidth in the common field, a special user info field, or any other field inthe trigger frame (i.e., the ICF frame) of 160 MHz: (i) if the number of User Info fields is larger than 8, each STA is allocated a 106-tone RU; (ii) if the number of User Info fields is between 5 and 8, each STA is allocated a 242-tone RU; (iii) if the number of User Info fields is 4 or less, each STA is allocated a 484-tone RU. For example, if the ICF includes an indication of an uplink bandwidth in the common field, a special user info field, or any other field inthe trigger frame (i.e., the ICF frame) of 320 MHz: (i) if the number of User Info fields is larger than 8, each STA is allocated a 242-tone RU; (ii) if the number of User Info fields is between 5 and 8, each STA is allocated a 484-tone RU; (iii) if the number of User Info fields is 4 or less, each STA is allocated a 484-tone RU.

TABLE 1

| Number of Users Info | Uplink Bandwidth Indicated in the ICF (MHz) | | | | |
|---|---|---|---|---|---|
| fields in the ICF | 20 | 40 | 80 | 160 | 320 |
| 2 | 106-tone RU | 242-tone RU | 484-tone RU | 484-tone RU | 484-tone RU |
| 3 | 52-tone RU | 106-tone RU | 242-tone RU | 484-tone RU | 484-tone RU |
| 4 | 52-tone RU | 106-tone RU | 242-tone RU | 484-tone RU | 484-tone RU |
| 5 to 8 | 26-tone RU | 52-tone RU | 106-tone RU | 242-tone RU | 484-tone RU |
| Larger than 8 | 26-tone RU | 26-tone RU | 52-tone RU | 106-tone RU | 242-tone RU |
| | [Maximum 9 | | | | |
| | Users are | | | | |
| | allowed in | | | | |
| | this case] | | | | |

It is noted that Table 1 provides an example of the RU sizes that can be used to allocate resources for the STAs in the ICF frame. However, example embodiments are not limited to the RU sizes listed, as other examples may be also considered following the same concept.

As introduced above, according to some embodiments, the punctured channels may not be considered in the allocation of the resources for the STAs to send their ICR and/or both the sharing AP and shared AP may have the same puncturing pattern in the common channel width which may be used for CoBF transmission.

As introduced above, in some embodiments, the MCS to transmit the ICR may be fixed to a value ICR-MCS which may be statically defined such as MCSO, e.g., determined by a field in the CoBF Invite frame or determined by a field which is negotiated in the Multi-AP Coordination (MAPC) agreement.

According to an embodiment, two identical ICF frames may be sent by the sharing AP and the shared AP using orthogonal resources. The resources allocated to transmit the ICF frames may be signalled in the CoBF Invite frame. The resources allocated to transmit the ICF frames may also be determined based on any of the following rules: (1) the lower part of the channel width is assigned to the sharing AP and the upper part of the channel width is assigned to the shared AP from low frequency to high frequency, or vice versa; and/or (2) if the channel width is 20 MHz, the lower 106-tone RU is assigned to the sharing AP and the upper 106-tone RU is assigned to the shared AP from low frequency to high frequency, or vice versa.

In an embodiment, the two identical ICF frames may carry the User Info fields based on the rules for the resource allocation discussed above (e.g., where resources allocated to each of the STAs from AP1 and AP2 to send the ICR are orthogonal in the frequency domain or the spatial domain and are determined following a set of rules such that both AP1 and AP2 may form identical allocations to the STAs and thus the ICF frame may be identical in both APs).

In an embodiment, two different ICF frames may be sent by the sharing AP and the shared AP using orthogonal resources. The resources allocated to transmit the ICF frames may be signalled in the CoBF Invite frame and/or may follow the above stated rules, e.g., where (1) the lower part of the channel width is assigned to the sharing AP and the upper part of the channel width is assigned to the shared AP from low frequency to high frequency; and/or (2) if the channel width is 20 MHz, the lower 106-tone RU is assigned to the sharing AP and the upper 106-tone RU is assigned to the shared AP from low frequency to high frequency.

In some embodiments, the two different ICF frames may carry User Info fields for their respective STAs. For instance, one ICF may be sent from AP1 to STA1 and may carry a User Info field identified by the association ID (AID) of STA1. Another ICF may be sent from AP2 to STA2 and may carry a User Info field identified by the association ID (AID) of STA2.

As introduced above, certain embodiments may include signaling in or associated with CoBF synchronization. In an embodiment, the sharing AP may indicate in a CoBF Sync Trigger frame the necessary information required to manage the concurrent transmission of the MU-BAR in both the sharing AP and shared AP as illustrated in the example of FIG. 10 discussed above.

In an embodiment, an identical MU-BAR may be transmitted by both AP1 and AP2 which includes User Info fields for all participating STAs associated with AP1 (e.g., STA1) and AP2 (e.g., STA2). The identical MU-BAR may be transmitted at substantially the same time (e.g., the exact same time) in both BSS1 of the sharing AP and BSS2 of the shared AP. The order of the User Info fields in the MU-BAR may include the User Info fields from AP1 followed by the User Info fields from AP2. The User Info fields of the same AP may be ordered in terms of the number of spatial streams allocated to each of them with the STA allocated the largest number of spatial streams being first in the order.

According to some embodiments, the resources allocated to each of the STAs associated with AP1 and AP2 to send the BA may be orthogonal in the frequency domain or the spatial domain, and/or the resources may be determined following a set of rules such that both AP1 and AP2 may form identical allocations to the STAs. For example, as a result, the MU-BAR frame may be identical in both APs. The set of rules for the resource allocation may include any of the following: (1) the STAs may be allocated frequency resources from lowest frequency to highest frequency based on the order and the number of the User Info fields in the MU-BAR frame; (2) the punctured channels may not be considered in the allocation of the resources for the STAs to send their BA and/or both sharing AP and shared AP may have the same puncturing pattern in the common channel width which will be used for CoBF transmission; and/or (3) the MCS to transmit the BA is fixed to a value BA-MCS which may be statically defined such as MCSO, determined by a field in the CoBF Sync Trigger frame or determined by a field which is negotiated in the Multi-AP Coordination (MAPC) agreement.

As introduced above, in an embodiment, the STAs may be allocated frequency resources (e.g., resources allocated to the STAs to transmit BA) from lowest frequency to highest frequency based on the order and/or the number of the User Info fields in the MU-BAR frame. Table 2 illustrates one example of such an allocation of frequency resources in the MU-BAR. For example, if the MU-BAR includes an indication of an uplink bandwidth in the common field, a special user info field, or any other field in the trigger frame (i.e., the MU-BAR frame) of 20 MHz: (i) if the number of User Info fields is larger than 4 but less than or equal to 9, each STA is allocated a 26-tone RU; (ii) if the number of User Info fields is 3 or 4, each STA is allocated a 52-tone RU; (iii) if the number of User Info fields is 2, each STA is allocated a 106-tone RU. For example, if the MU-BAR includes an indication of an uplink bandwidth in the common field, a special user info field, or any other field in the trigger frame (i.e., the MU-BAR frame) of 40 MHz: (i) if the number of User Info fields is larger than 8, each STA is allocated a 26-tone RU; (ii) if the number of User Info fields between 5 and 8, each STA is allocated a 52-tone RU; (iii) if the number of User Info fields is 3 or 4 each STA is allocated a 106-tone RU; (iv) if the number of User Info fields is 2 each STA is allocated a 242-tone RU. For example, if the MU-BAR includes an indication of an uplink bandwidth in the common field, a special user info field, or any other field in the trigger frame (i.e., the MU-BAR frame) of 80 MHz: (i) if the number of User Info fields is larger than 8, each STA is allocated a 52-tone RU; (ii) if the number of User Info fields is between 5 and 8, each STA is allocated a 106-tone RU; (iii) if the number of User Info fields is 3 or 4, each STA is allocated a 242-tone RU; (iv) if the number of User Info fields is 2, each STA is allocated a 484-tone RU. For example, if the MU-BAR includes an indication of an uplink bandwidth in the common field, a special user info field, or any other field in the trigger frame (i.e., the MU-BAR frame) of 160 MHz: (i) if the number of User Info fields is larger than 8, each STA is allocated a 106-tone RU; (ii) if the number of User Info fields is between 5 and 8, each STA is allocated a 242-tone RU; (iii) if the number of User Info fields is 4 or less, each STA is allocated a 484-tone RU. For example, if the MU-BAR includes an indication of an uplink bandwidth in the common field, a special user info field, or any other field in the trigger frame (i.e., the MU-BAR frame) of 320 MHz: (i) if the number of User Info fields is larger than 8, each STA is allocated a 242-tone RU; (ii) if the number of User Info fields is between 5 and 8, each STA is allocated a 484-tone RU; (iii) if the number of User Info fields is 4 or less, each STA is allocated a 484-tone RU.

TABLE 2

| Number of Users Info | Uplink Bandwidth Indicated in the MU-BAR (MHz) | | | | |
|---|---|---|---|---|---|
| fields in the MU-BAR | 20 | 40 | 80 | 160 | 320 |
| 2 | 106-tone RU | 242-tone RU | 484-tone RU | 484-tone RU | 484-tone RU |
| 3 | 52-tone RU | 106-tone RU | 242-tone RU | 484-tone RU | 484-tone RU |
| 4 | 52-tone RU | 106-tone RU | 242-tone RU | 484-tone RU | 484-tone RU |
| 5 to 8 | 26-tone RU | 52-tone RU | 106-tone RU | 242-tone RU | 484-tone RU |
| Larger than 8 | 26-tone RU | 26-tone RU | 52-tone RU | 106-tone RU | 242-tone RU |
| | [Maximum 9 | | | | |
| | Users are | | | | |
| | allowed in | | | | |
| | this case] | | | | |

It is noted that Table 2 provides an example of the RU sizes that can be used to allocate resources for the STAs in the MU-BAR frame (e.g., resources allocated to the STA to transmit BA). However, example embodiments are not limited to the RU sizes listed, as other examples may be also considered following the same concept.

As introduced above, according to an embodiment, the punctured channels may not be considered in the allocation of the resources for the STAs to send their BA and/or both sharing AP and shared AP may have the same puncturing pattern in the common channel width which will be used for CoBF transmission.

As also introduced above, according to an embodiment, the MCS to transmit the BA may be fixed to a value BA-MCS which may be statically defined such as MCSO, determined by a field in the CoBF Sync Trigger frame or determined by a field which is negotiated in the Multi-AP Coordination (MAPC) agreement.

In some embodiments, two identical MU-BAR frames may be sent by the sharing AP and the shared AP using orthogonal resources. For example, the resources allocated to transmit the MU-BAR frames may be signalled in the CoBF Invite frame. The resources allocated to transmit the MU-BAR frames may also be determined based on any of the following rules: (1) the lower part of the Channel width is assigned to the sharing AP, and the upper part of the Channel width is assigned to the shared AP from low frequency to high frequency, or vice versa; and/or (2) if the Channel width is 20 MHz, the lower 106-tone RU is assigned to the sharing AP and the upper 106-tone RU is assigned to the shared AP from low frequency to high frequency, or vice versa.

According to certain embodiments, the two identical MU-BAR frames may carry the User Info fields based on the rules for the resource allocation discussed above (e.g., (1) the STAs may be allocated frequency resources from lowest frequency to highest frequency based on the order and the number of the User Info fields in the MU-BAR frame; (2) the punctured channels may not be considered in the allocation of the resources for the STAs to send their BA and/or both sharing AP and shared AP may have the same puncturing pattern in the common channel width which will be used for CoBF transmission; and/or (3) the MCS to transmit the BA is fixed to a value BA-MCS which may be statically defined such as MCSO, determined by a field in the CoBF Sync Trigger frame or determined by a field which is negotiated in the Multi-AP Coordination (MAPC) agreement).

In an embodiment, two different MU-BAR frames may be sent by the sharing AP and the shared AP using orthogonal resources. The resources allocated to transmit the MU-BAR frames may be signalled in the CoBF Sync Trigger frame and may follow the above-stated rules for allocating resources to transmit the MU-BAR frames (e.g., (1) the lower part of the Channel width is assigned to the sharing AP, and the upper part of the Channel width is assigned to the shared AP from low frequency to high frequency, or vice versa; and/or (2) if the Channel width is 20 MHz, the lower 106-tone RU is assigned to the sharing AP and the upper 106-tone RU is assigned to the shared AP from low frequency to high frequency, or vice versa).

According to some embodiments, the two different MU-BAR frames may carry User Info fields for their respective STAs. For instance, one MU-BAR may be sent from AP1 to STA1 and may carry a User Info field identified by the association ID (AID) of STA1, and another MU-BAR may be sent from AP2 to STA2 and may carry a User Info field identified by the association ID (AID) of STA2.

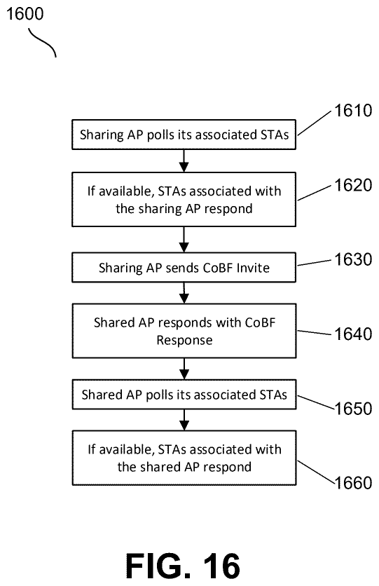

FIG. 16 illustrates an example flow diagram of a method 1600, according to certain embodiments. As illustrated in the example of FIG. 16, at 1610, a sharing AP (e.g., AP1 illustrated in the examples of any of FIGS. 6-15) may poll its associated STA(s). For example, the associated STA(s) may be STAs that are selected to participate in the CoBF transmission in the current TXOP. For example, the polling by the sharing AP may be performed by sending an ICF to the selected STA(s). In an embodiment, the ICF may allocate orthogonal resources for each of the selected STA(s) to respond, e.g., by sending an ICR. In an embodiment, at 1620, if the STA(s) is/are available, they may respond with an ICR to indicate their availability. In an embodiment, if one or more of the selected STA(s) responds with positive available status, at 1630, the sharing AP may initiate the CoBF transmission by sending the CoBF Invite frame. If the shared AP (e.g., AP2 illustrated in the examples of any of FIGS. 6-15) is available to participate in the CoBF transmission, at 1640, the shared AP responds with a CoBF Response frame, e.g., with a status code indicating acceptance. Otherwise, the shared AP responds with a CoBF Response frame, e.g., with a status code indicating declining (rejection). At 1650, the shared AP (e.g., if it indicated in the CoBF Response frame that it is available for CoBF transmission) may poll its associated STAs that are selected to participate in the CoBF transmission (in the current TXOP), e.g., by sending an ICF. The ICF may include an allocation of orthogonal resources for each of the selected STAs to respond, e.g., by sending an ICR. For example, at 1660, if the STA(s) are available, they may respond by sending an ICR. In one embodiment, the sharing AP may monitor the OBSS STA(s) response. For example, if one or more of the selected STAs of the shared AP responds with positive available status, the sharing AP may trigger the coordinated transmission by sending a CoBF Sync Trigger frame (e.g., the sharing AP may send the CoBF invite on condition that the STA(s) associated with the sharing AP and/or the STAs associated with the shared AP respond to the polling, e.g., by sending an ICR in response to an ICF); however, if no STA of the shared AP responds with positive availability, the sharing AP (which is also the TXOP owner) may resume transmission to its associated STAs in a non-coordinated manner or in a coordinated manner with other APs (e.g., APs other than the current shared AP). In another example, the sharing AP may not need to monitor the OBSS STAs' ICRs and simply go ahead with CoBF transmission according to the spatial stream configurations sent in the CoBF Invite frame as if the shared AP and its associated STAs would participate in the CoBF transmission as configured regardless of the availability of the shared AP's associated STAs.

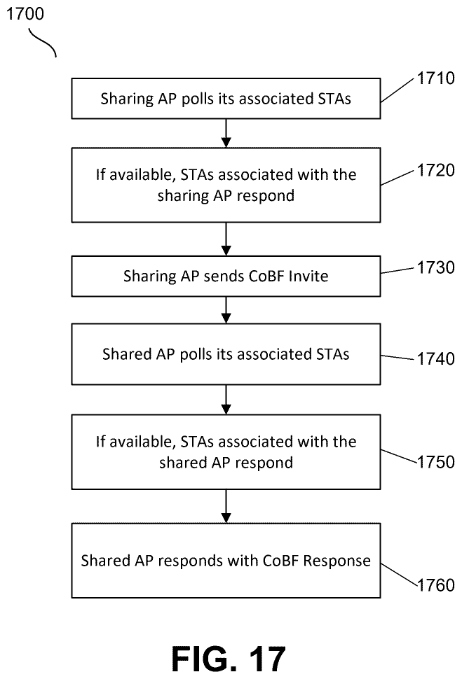

FIG. 17 illustrates an example flow diagram of a method 1700, according to certain embodiments. As illustrated in the example of FIG. 17, at 1710, the sharing AP (e.g., AP1 illustrated in the examples of any of FIGS. 6-15) may poll its associated STA(s). For example, the associated STA(s) may be STAs that are selected to participate in the CoBF transmission in the current TXOP. For example, the polling by the sharing AP may be performed by sending an ICF to the selected STA(s). In an embodiment, the ICF may allocate orthogonal resources for each of the selected STA(s) to respond, e.g., by sending an ICR. In an embodiment, at 1720, if one or more of the selected STAs are available, they may respond with positive available status (e.g., in an ICR). Based on the indication of availability received from the STA(s), at 1730, the sharing AP may initiate the CoBF transmission by sending a CoBF Invite frame (e.g., to the shared AP). If the shared AP is available to participate in the CoBF transmission, at 1740, the shared AP polls its associated STA(s). For example, the associated STA(s) may be STAs that are selected to participate in the CoBF transmission in the current TXOP. The shared AP may poll its associated STA(s) by sending an ICF. In an embodiment, the ICF may allocate orthogonal resources for each of the selected STAs to respond, e.g., by sending an ICR. At 1750, if available, the selected STA(s) may respond indicating their availability. If one or more of the selected STA(s) responds with positive available status, at 1760, the shared AP sends a CoBF Response frame with a status code indicating acceptance. Otherwise, the shared AP may respond with a CoBF Response frame with a status code indicating that it declines (rejection) the CoBF invite. The sharing AP, if it receives an acceptance (e.g., an acceptance code) from the shared AP, may trigger the coordinated transmission by sending a CoBF Sync Trigger frame. The sharing AP (which is also the TXOP owner), if it receives a rejection (e.g., a rejection code) from the shared AP, may resume transmission to its associated STA(s) in a non-coordinated manner or in a coordinated manner with other APs (e.g., with APs other than the current shared AP).

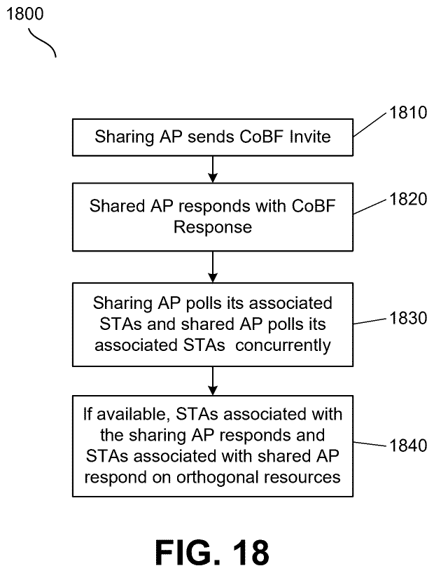

FIG. 18 illustrates an example flow diagram of a method 1800, according to certain embodiments. As illustrated in the example of FIG. 18, at 1810, the sharing AP (e.g., AP1 illustrated in the examples of any of FIGS. 6-15) may initiates a CoBF transmission phase, e.g., by sending a CoBF Invite frame. If the shared AP is available to participate in the CoBF transmission, at 1820, the shared AP may respond with a CoBF Response frame, e.g., with a status code indicating acceptance. Otherwise, the shared AP may respond with a CoBF Response frame, e.g., with a status code indicating that it declines (rejection). At 1830, the sharing AP and the shared AP then poll their selected STAs by transmitting ICFs concurrently (e.g., according to any of the options discussed below). For example, the ICF(s) may allocate orthogonal resources for the STAs selected from both APs to participate in the CoBF transmission. According to certain embodiments, three options to send the concurrent ICF may be provided: (1) an identical ICF may be transmitted by both the sharing AP and the shared AP which includes User Info fields for all participating STAs from both the sharing and the shared APs at the same time using the same frequency or spatial resources; (2) two identical ICF frames may be sent by the sharing AP and the shared AP using orthogonal resources; and/or (3) two different ICF frames may be sent by the sharing AP and the shared AP using orthogonal resources. As further illustrated in the example of FIG. 18, at 1840, if available, the STAs associated with the sharing AP and the shared AP may respond on orthogonal resources in concurrent ICRs.

In some embodiments, the sharing AP may monitor for responses from the STA(s) associated with the sharing AP and from STA(s) associated with the shared AP. If one or more STAs associated with the sharing AP responds with positive available status and one or more of the selected STAs associated with the shared AP responds with positive available status, the sharing AP may trigger the coordinated transmission by sending a CoBF Sync Trigger frame. If no STA of the shared AP responds with positive availability, the sharing AP (which is also the TXOP owner) may resume transmission to its associated STAs in a non-coordinated manner if any of them responds with positive available status. If no STA of the sharing AP responds with positive availability but one or more STAs of the shared AP responds with positive availability, the sharing AP may still go ahead with a CoBF Sync Trigger frame with proper configurations that allocate all the spatial streams to the shared AP.

In some embodiments, the sharing AP may not need to monitor for ICRs from STAs associated with the shared AP. For example, if one or more of its own associated STAs respond with positive availability status, the sharing AP may just go ahead with the CoBF Sync Trigger frame and CoBF transmission according to the spatial stream configuration sent in the CoBF Invite frame as if the shared AP and its associated STAs would participate in the CoBF transmission as configured regardless of the availability of the shared AP's associated STAs. If none of its own associated STAs respond with positive availability status, the sharing AP may not send a CoBF Sync Trigger frame, or it may still go ahead with a CoBF Sync Trigger frame that either follows the spatial stream configuration indicated in the CoBF Invite frame, or sets new proper configurations that allocate all the spatial streams to the shared AP.

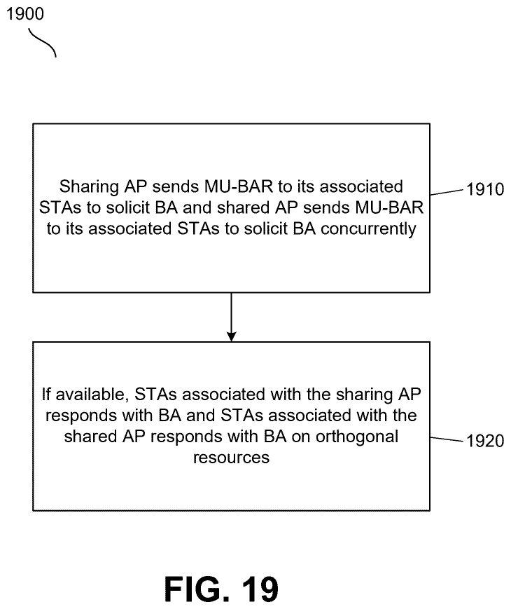

FIG. 19 illustrates an example flow diagram of a method 1900, according to certain embodiments. As illustrated in the example of FIG. 19, at 1910, both the sharing AP and shared AP may concurrently send a MU-BAR to their associated STAs to solicit BA. In some embodiments, three options may be provided to send the concurrent MU-BAR: (1) an identical MU-BAR may be transmitted by both the sharing AP and the shared AP which includes User Info fields for all participating STAs from both the sharing and the shared APs at the same time using the same frequency or spatial resources; (2) two identical MU-BAR frames may be sent by the sharing AP and the shared AP using orthogonal resources; and/or (3) two different MU-BAR frames may be sent by the sharing AP and the shared AP using orthogonal resources. At 1920, if available, then the STA(s) associated with the sharing AP may respond with BA and STA(s) associated with the shared AP may respond with BA on orthogonal resources.

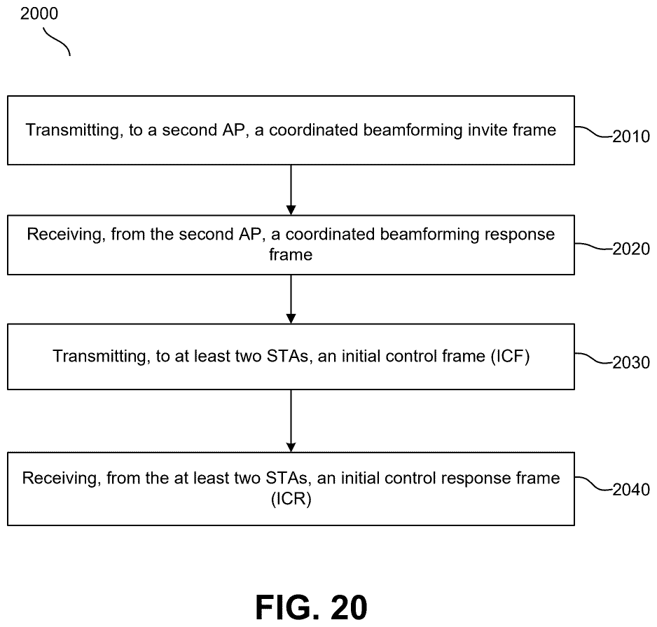

FIG. 20 illustrates an example flow diagram of a method 2000 relating to CoBF in Wi-Fi (e.g., relating to the transmission phase in CoBF), according to some example embodiments. The example method 2000 of FIG. 20 and accompanying disclosures herein may include, may be based on, or may be a synthesization of various embodiments or elements discussed in detail above, such as those discussed with respect to FIGS. 6-15. For convenience and simplicity of exposition, the example of FIG. 20 may be described with reference to the architecture or system described above with respect to FIGS. 1A-1D, for instance. However, the example method 2000 depicted in FIG. 20 may be carried out using different architectures as well. According to some embodiments, the method 2000 of FIG. 20 may be implemented by an AP (e.g., AP1 and/or AP2 in the examples of FIGS. 6-15), or the like. In one embodiment, the method 2200 may be implemented by a sharing AP or AP1 as illustrated in FIGS. 6-15.

It is noted that the method 2000 of FIG. 20 may include further steps, procedures or details as discussed in detail elsewhere in this disclosure. As such, the method 2000 of FIG. 20 may be modified to include any of the steps, procedures, elements and/or details illustrated and/or discussed in the foregoing. Moreover, it is noted that the method and/or blocks of FIG. 20 may be modified to include, or to be replaced by, any one or more of the procedures, elements or blocks discussed elsewhere herein. As such, one of ordinary skill in the art would understand that FIG. 20 is provided as one example and modifications thereto are possible while remaining within the scope of certain example embodiments as described herein.

As illustrated in the example of FIG. 20, the method 2000 may include, at 2010, a first AP transmitting, to a second AP, a coordinated beamforming invite frame including information inviting or requesting the second AP to participate in coordinated beamforming with the first AP.

In the example of FIG. 20, the method 2000 may include, at 2020, receiving, from the second AP, a coordinated beamforming response frame including information indicating an acceptance (or possibly a rejection) of the coordinated beamforming with the first AP.

In the example of FIG. 20, the method 2000 may include, at 2030, transmitting, to at least two STAs (e.g., to a first STA associated with the first AP and a second STA associated with the second AP), an initial control frame (ICF) including information requesting availability information for the at least two STAs (e.g., requesting whether the STAs are available for communication with the first and/or second APs). In certain embodiments, at least one STA, from among the at least two STAs, may be associated with the first AP, and at least another STA, from among the at least two STAs, may be associated with the second AP (e.g., a first STA may be associated with the first AP and a second STA may be associated with the second AP, or a first and second STA may be associated with the first AP and a third a fourth STA may be associated with the second AP).

In the example of FIG. 20, the method 2000 may include, at 2040, receiving, from the at least two STAs, an initial control response frame (ICR) including availability acceptance information indicating the availability of the at least two STAs to receive coordinated transmissions from the first AP and the second AP (e.g., based on the ICF, each of the at least two STAs may send, and the first AP may receive, an ICR indicating whether the STAs are available for communication with the first and/or second AP). For example, the receiving 2040 may include receiving respective ICRs from the at least two STAs (e.g., a first ICR may be received from a first STA associated with the first AP and a second ICR may be received from a second STA associated with the second AP).

In an embodiment, the first AP has obtained a TXOP that is or will be shared by the first AP with the second AP, as discussed above.

In an embodiment, the method may include transmitting, to the second AP, a trigger frame (e.g., CoBF sync frame as illustrated in the examples of FIGS. 6-15) including information for synchronizing concurrent downlink (DL) transmissions from both the first and the second APs. The concurrent DL transmissions are concurrent transmissions of spatial streams occupying a same wireless medium based on the coordinated beamforming.

In an embodiment, the method may include transmitting, to the at least one of the at least two STAs that is associated with the first AP (e.g., to the first STA associated with the first AP), based on the synchronizing, a beamformed DL physical protocol data unit (DL PPDU) transmission.

In an embodiment, the trigger frame may include resource allocation information associated with the first AP and/or resource allocation information associated with the second AP.

In an embodiment, the method may include transmitting, to the at least one of the at least two STAs that is associated with the first AP (e.g., to the first STA associated with the first AP), a multi-user block acknowledgement request (MU-BAR), e.g., for soliciting a block acknowledgement (BA).

In an embodiment, resource unit (RU) tones for the ICR may be allocated based on an uplink bandwidth indicated in the ICF and/or the number of user information fields in the ICF.

In an embodiment, resource unit (RU) tones for the multi-user block acknowledgement request (MU-BAR) may be allocated based on an uplink bandwidth indicated in the MU-BAR and/or the number of user information fields in the MU-BAR.

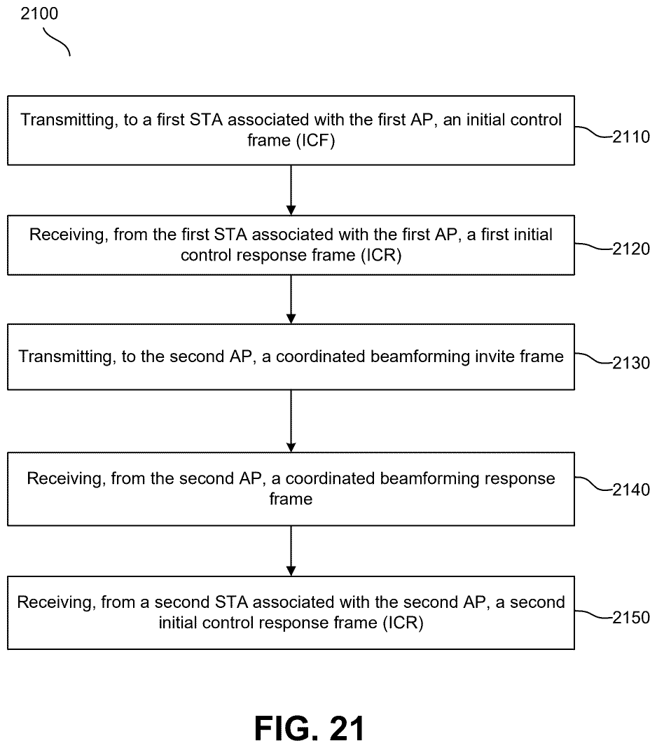

FIG. 21 illustrates an example flow diagram of a method 2100 relating to CoBF in Wi-Fi (e.g., relating to the transmission phase in CoBF), according to some example embodiments. The example method 2100 of FIG. 21 and accompanying disclosures herein may include, may be based on, or may be a synthesization of various embodiments or elements discussed in detail above, such as those discussed with respect to FIGS. 6-15. For convenience and simplicity of exposition, the example of FIG. 21 may be described with reference to the architecture or system described above with respect to FIGS. 1A-1D, for instance. However, the example method 2100 depicted in FIG. 21 may be carried out using different architectures as well. According to some embodiments, the method 2100 of FIG. 21 may be implemented by an AP (e.g., AP1 and/or AP2 in the examples of FIGS. 6-15), or the like. In one embodiment, the method 2100 may be implemented by a sharing AP or AP1 as illustrated in FIGS. 6-15.

It is noted that the method 2100 of FIG. 21 may include further steps, procedures or details as discussed in detail elsewhere in this disclosure. As such, the method 2100 of FIG. 21 may be modified to include any of the steps, procedures, elements and/or details illustrated and/or discussed in the foregoing. Moreover, it is noted that the method and/or blocks of FIG. 21 may be modified to include, or to be replaced by, any one or more of the procedures, elements or blocks discussed elsewhere herein. As such, one of ordinary skill in the art would understand that FIG. 21 is provided as one example and modifications thereto are possible while remaining within the scope of certain example embodiments as described herein.

As illustrated in the example of FIG. 21, the method 2100 may include, at 2110, a first AP transmitting, to a first STA associated with the first AP, an initial control frame (ICF) including information requesting availability information for the first STA (e.g., requesting whether the first STA is available for communication with the first AP and/or a second AP).

In the example of FIG. 21, the method 2100 may include, at 2120, receiving, from the first STA associated with the first AP, e.g., based on the ICF, a first initial control response frame (ICR) including availability acceptance information indicating availability to receive transmissions from the first AP (e.g., indicating whether the first STA is available and/or accepts receiving transmission from the first AP).

In the example of FIG. 21, the method 2100 may include, at 2130, transmitting, to the second AP, a coordinated beamforming invite frame including information inviting or requesting the second AP to participate in coordinated beamforming with the first AP.

In the example of FIG. 21, the method 2100 may include, at 2140, receiving, from the second AP, a coordinated beamforming response frame including information indicating an acceptance of the coordinated beamforming with the first AP (e.g. indicating whether the second AP accepts or declines participating in the coordinated beamforming with the first AP).

In the example of FIG. 21, the method 2100 may include, at 2150, receiving, from a second STA associated with the second AP (e.g. a second STA that is different from the first STA), a second initial control response frame (ICR) including availability acceptance information indicating availability to receive transmissions from the second AP (e.g., indicating whether the second STA is available and/or accepts receiving transmission from the second AP that is participating in the coordinated beamforming).

In an embodiment, the first AP has obtained a TXOP that is or will be shared by the first AP with the second AP.

In an embodiment, the method may include transmitting, to the second AP, a trigger frame (e.g., CoBF sync frame as illustrated in the examples of FIGS. 6-15) including information for synchronizing concurrent downlink (DL) transmissions from both the first AP and the second AP. The concurrent DL transmissions may be concurrent transmissions of spatial streams occupying a same wireless medium based on the coordinated beamforming.

In an embodiment, the trigger frame includes resource allocation information associated with the first AP and/or resource allocation information associated with the second AP.

In an embodiment, the method may include transmitting, to the first STA that is associated with the first AP, based on the synchronizing, a beamformed DL physical protocol data unit (DL PPDU) transmission.

In an embodiment, the method may include transmitting, to the first STA that is associated with the first AP, a multi-user block acknowledgement request (MU-BAR) for soliciting a block acknowledgement (BA) from the first STA.

In an embodiment, resource unit (RU) tones for the ICR may be allocated based on an uplink bandwidth indicated in the ICF and/or the number of user information fields in the ICF.

In an embodiment, resource unit (RU) tones for the multi-user block acknowledgement request (MU-BAR) may be allocated based on uplink bandwidth indicated in the MU-BAR and/or the number of user information fields in the MU-BAR.

In an embodiment, the second ICR frame may be received after a certain period of time from receiving the coordinated beamforming response frame (e.g., the second ICR frame may be received after the second AP sends an ICF as shown in the example of FIG. 15).

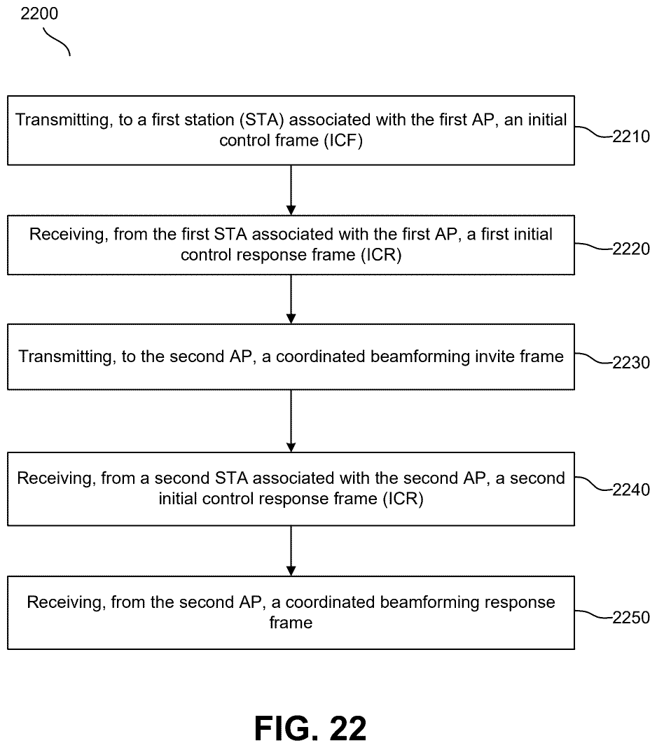

FIG. 22 illustrates an example flow diagram of a method 2200 relating to CoBF in Wi-Fi (e.g., relating to the transmission phase in CoBF), according to some example embodiments. The example method 2200 of FIG. 22 and accompanying disclosures herein may include, may be based on, or may be a synthesization of various embodiments or elements discussed in detail above, such as those discussed with respect to FIGS. 6-15. For convenience and simplicity of exposition, the example of FIG. 22 may be described with reference to the architecture or system described above with respect to FIGS. 1A-1D, for instance. However, the example method 2200 depicted in FIG. 22 may be carried out using different architectures as well. According to some embodiments, the method 2200 of FIG. 22 may be implemented by an AP (e.g., AP1 and/or AP2 in the examples of FIGS. 6-15), or the like. In one embodiment, the method 2200 may be implemented by a sharing AP or AP1 as illustrated in FIGS. 6-15.

It is noted that the method 2200 of FIG. 22 may include further steps, procedures or details as discussed in detail elsewhere in this disclosure. As such, the method 2200 of FIG. 22 may be modified to include any of the steps, procedures, elements and/or details illustrated and/or discussed in the foregoing. Moreover, it is noted that the method and/or blocks of FIG. 22 may be modified to include, or to be replaced by, any one or more of the procedures, elements or blocks discussed elsewhere herein. As such, one of ordinary skill in the art would understand that FIG. 22 is provided as one example and modifications thereto are possible while remaining within the scope of certain example embodiments as described herein.

As illustrated in the example of FIG. 22, the method 2200 may include, at 2210, transmitting, to a first station (STA) associated with the first AP, an initial control frame (ICF) including information requesting availability information for the first STA (e.g., requesting whether the first AP is available for communication with the first AP).

In the example of FIG. 22, the method 2200 may include, at 2220, receiving, from the first STA associated with the first AP, e.g., based on the ICF, a first initial control response frame (ICR) including availability acceptance information indicating availability to receive transmissions from the first AP (e.g., indicating whether the first STA is available and/or accepts to receive communications from the first AP).

In the example of FIG. 22, the method 2200 may include, at 2230, transmitting, to the second AP, a coordinated beamforming invite frame including information inviting or requesting the second AP to participate in coordinated beamforming with the first AP.

In the example of FIG. 22, the method 2200 may include, at 2240, receiving, from a second STA associated with the second AP, a second initial control response frame (ICR) including availability acceptance information indicating availability to receive transmissions from the second AP (e.g., indicating whether the second STA is available and/or accepts to receive communications from the second AP).

In the example of FIG. 22, the method 2200 may include, at 2250, receiving, from the second AP, a coordinated beamforming response frame including information indicating an acceptance or a rejection of the coordinated beamforming with the first AP;

In an embodiment, the first AP has obtained a TXOP that is or will be shared by the first AP with the second AP.

In an embodiment, the method may include transmitting, to the second AP, a trigger frame (e.g., CoBF sync frame as illustrated in the examples of FIGS. 6-15) including information for synchronizing concurrent downlink (DL) transmissions from both the first AP and the second AP. The concurrent DL transmissions may be concurrent transmissions of spatial streams occupying a same wireless medium based on the coordinated beamforming.

In an embodiment, the trigger frame may include resource allocation information associated with the first AP and/or resource allocation information associated with the second AP.

In an embodiment, the method may include transmitting, to the first STA that is associated with the first AP, based on the synchronizing, a beamformed DL physical protocol data unit (DL PPDU) transmission.

In an embodiment, the method may include transmitting, to the first STA that is associated with the first AP, a multi-user block acknowledgement request (MU-BAR), e.g., for soliciting a block acknowledgement (BA) from the first STA.

In an embodiment, resource unit (RU) tones for the ICR may be allocated based on an uplink bandwidth indicated in the ICF and/or the number of user information fields in the ICF.

In an embodiment, resource unit (RU) tones for the multi-user block acknowledgement request (MU-BAR) may be allocated based on uplink bandwidth indicated in the MU-BAR and/or the number of user information fields in the MU-BAR.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

In some example embodiments described herein, (e.g., configuration) information may be described as received by a WTRU from the network, for example, through system information or via any kind of protocol message. Although not explicitly mentioned throughout embodiments described herein, the same (e.g., configuration) information may be pre-configured in the WTRU (e.g., via any kind of pre-configuration methods such as e.g., via factory settings), such that this (e.g., configuration) information may be used by the WTRU without being received from the network.

Any characteristic, variant or embodiment described for a method is compatible with an apparatus device comprising means for processing the disclosed method, such as with a device comprising a processor configured to process the disclosed method, a computer program product comprising program code instructions and a non-transitory computer-readable storage medium storing program instructions.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

Although various embodiments have been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although some example embodiments are illustrated and described herein, the invention is not intended to just be limited to the details shown. Rather, various modifications and variations may be made in the details within the scope and range of equivalents of the claims and without departing from the spirit or scope invention.

### REFERENCES

The following references may have been referred to hereinabove, each of which is incorporated herein by reference in its entirety:
IEEE Std 802.11™-2020: Wireless LAN Medium Access Control (MAC) and Physical Layer (PHY) Specifications;
IEEE P802.11ax™/D8.0: Wireless LAN Medium Access Control (MAC) and Physical Layer (PHY) Specifications;
IEEE P802.11be™/D7.0: Wireless LAN Medium Access Control (MAC) and Physical Layer (PHY) Specifications, August 2024;
IEEE P802.11bn™/D0.2: Wireless LAN Medium Access Control (MAC) and Physical Layer (PHY) Specifications, March 2025.

1. A first access point (AP), comprising:
circuitry, including any of a processor and transceiver, configured to
transmit, to a second AP, a coordinated beamforming invite frame including first information inviting the second AP to participate in coordinated beamforming with the first AP;
receive, from the second AP, a coordinated beamforming response frame including second information indicating an acceptance of the coordinated beamforming with the first AP;
transmit, to at least two stations (STAs), an initial control frame (ICF) including third information requesting availability information for the at least two STAs, wherein at least one STA of the at least two STAs is associated with the first AP and at least another STA of the at least two STAs is associated with the second AP; and
based on the ICF, receive, from the at least two STAs, an initial control response frame (ICR) including availability acceptance information indicating availability to receive coordinated transmissions from the first AP and the second AP.

2. The first AP of claim 1, wherein the first AP has obtained a transmit opportunity (TXOP) that is shared by the first AP with the second AP.

3. The first AP of claim 1, configured to:
transmit, to the second AP, a trigger frame including fourth information for synchronizing concurrent downlink (DL) transmissions from both the first and the second APs, wherein the concurrent DL transmissions are concurrent transmissions of spatial streams occupying a same wireless medium based on the coordinated beamforming; and
transmit, to the at least one of the at least two STAs that is associated with the first AP, based on the synchronizing, a beamformed DL physical protocol data unit (DL PPDU) transmission.

4. The first AP of claim 3, further configured to:
transmit, to the at least one of the at least two STAs that is associated with the first AP, a multi-user block acknowledgement request (MU-BAR) for soliciting a block acknowledgement (BA).

5. The first AP of claim 1, wherein resource unit (RU) tones for the ICR are allocated based on an uplink bandwidth indicated in the ICF and number of user information fields in the ICF.

6. The first AP of claim 4, wherein resource unit (RU) tones for the multi-user block acknowledgement request (MU-BAR) are allocated based on an uplink bandwidth indicated in the MU-BAR and number of user information fields in the MU-BAR.

7. The first AP of claim 3, wherein the trigger frame comprises resource allocation information associated with the first AP and resource allocation information associated with the second AP.

8. A method, implemented by a first access point (AP), the method comprising:
transmitting, to a second AP, a coordinated beamforming invite frame including first information inviting the second AP to participate in coordinated beamforming with the first AP;
receiving, from the second AP, a coordinated beamforming response frame including second information indicating an acceptance of the coordinated beamforming with the first AP;
transmitting, to at least two stations (STAs), an initial control frame (ICF) including third information requesting availability information for the at least two STAs, wherein at least one STA of the at least two STAs is associated with the first AP and at least another STA of the at least two STAs is associated with the second AP; and
based on the ICF, receiving, from the at least two STAs, an initial control response frame (ICR) including availability acceptance information indicating availability to receive coordinated transmissions from the first AP and the second AP.

9. The method of claim 8, wherein the first AP has obtained a transmit opportunity (TXOP) that is shared by the first AP with the second AP.

10. The method of claim 8, comprising:
transmitting, to the second AP, a trigger frame including fourth information for synchronizing concurrent downlink (DL) transmissions from both the first and the second APs, wherein the concurrent DL transmissions are concurrent transmissions of spatial streams occupying a same wireless medium based on the coordinated beamforming; and
transmitting, to the at least one of the at least two STAs that is associated with the first AP, based on the synchronizing, a beamformed DL physical protocol data unit (DL PPDU) transmission.

11. The method of claim 10, comprising:
transmitting, to the at least one of the at least two STAs that is associated with the first AP, a multi-user block acknowledgement request (MU-BAR) for soliciting a block acknowledgement (BA).

12. The method of claim 8, wherein resource unit (RU) tones for the ICR are allocated based on an uplink bandwidth indicated in the ICF and number of user information fields in the ICF.

13. The method of claim 11, wherein resource unit (RU) tones for the multi-user block acknowledgement request (MU-BAR) are allocated based on an uplink bandwidth indicated in the MU-BAR and number of user information fields in the MU-BAR.

14. The method of claim 10, wherein the trigger frame comprises resource allocation information associated with the first AP and resource allocation information associated with the second AP.

15. A first access point (AP), comprising:
circuitry, including any of a processor and transceiver, configured to
transmit, to a first station (STA) associated with the first AP, an initial control frame (ICF) including first information requesting availability information for the first STA;
receive, from the first STA associated with the first AP, based on the ICF, a first initial control response frame (ICR) including availability acceptance information indicating availability to receive transmissions from the first AP;
transmit, to a second AP, a coordinated beamforming invite frame including second information inviting the second AP to participate in coordinated beamforming with the first AP;
receive, from the second AP, a coordinated beamforming response frame including third information indicating an acceptance of the coordinated beamforming with the first AP; and
receive, from a second STA associated with the second AP, a second initial control response frame (ICR) including availability acceptance information indicating availability to receive transmissions from the second AP.

16. The first AP of claim 15, wherein the first AP has obtained a transmit opportunity (TXOP) that is shared by the first AP with the second AP.

17. The first AP of claim 15, configured to:
transmit, to the second AP, a trigger frame including fourth information for synchronizing concurrent downlink (DL) transmissions from both the first and the second APs, wherein the concurrent DL transmissions are concurrent transmissions of spatial streams occupying a same wireless medium based on the coordinated beamforming; and
transmit, to the first STA that is associated with the first AP, based on the synchronizing, a beamformed DL physical protocol data unit (DL PPDU) transmission.

18. The first AP of claim 15, further configured to:
transmit, to the first STA that is associated with the first AP, a multi-user block acknowledgement request (MU-BAR) for soliciting a block acknowledgement (BA) from the first STA.

19. The first AP of claim 15, wherein resource unit (RU) tones for the ICR are allocated based on an uplink bandwidth indicated in the ICF and number of user information fields in the ICF.

20. The first AP of claim 18, wherein resource unit (RU) tones for the multi-user block acknowledgement request (MU-BAR) are allocated based on uplink bandwidth indicated in the MU-BAR and number of user information fields in the MU-BAR.

21. The first AP of claim 17, wherein the trigger frame comprises resource allocation information associated with the first AP and resource allocation information associated with the second AP.

22. The first AP of claim 15, wherein the second ICR frame is received after a certain period of time from receiving the coordinated beamforming response frame.
